(19) United States
(12) Patent Application Publication
(10) Pub. No.: US 2024/0270521 A1
(43) Pub. Date: Aug. 15, 2024

(54) SLIDING BUMPER ASSEMBLY

(71) Applicant: IDEAL WAREHOUSE INNOVATIONS, INC., Vaughan (CA)

(72) Inventor: Joseph J. DI BIASE, Vaughan (CA)

(21) Appl. No.: 18/571,494

(22) PCT Filed: Jun. 24, 2022
(86) PCT No.: PCT/CA2022/051022

§ 371 Date: Dec. 18, 2023

Related U.S. Application Data
(60) Provisional application No. 63/215,119, filed on Jun. 25, 2021.

(30) Foreign Application Priority Data
Jun. 25, 2021 (US) 63215119

(51) Int. Cl. B65G 69/00

(52) U.S. Cl. CPC B65G 69/001

(57) ABSTRACT

A bumper apparatus comprising a mounting structure attachable to a surface, and a bumper assembly slidably and removably engaged with the mounting structure. The mounting structure comprises a bumper assembly engagement structure. The bumper assembly comprises: a mount engagement structure for longitudinal slidable engagement with the bumper assembly engagement structure, a bumper attached to the mount engagement structure, and a biasing mechanism. In use, the removeable bumper assembly rests upon a biasing mechanism retaining structure attached generally to a bottom end of the mounting structure, in a neutral position when no unbalanced external force is applied at least partially longitudinally to the bumper assembly. When the bumper assembly is acted upon by such force applied toward the biasing mechanism retaining structure to move the bumper assembly into a lowered position, the biasing mechanism biases the bumper assembly upward, toward the neutral position.

### FIELD

The presently described subject-matter relates to bumpers for supporting the trailers of semi-tractor-trailer trucks parked at loading docks, and more particularly to surface-mountable slidable bumpers for vertical movement with a trailer during loading and unloading operations.

### BACKGROUND

A semi-tractor-trailer truck is the combination of a tractor unit and one, or more, semi-trailers to carry freight, wherein the semi-trailer attaches to the tractor unit with a type of hitch called a fifth-wheel. A semi-tractor-trailer truck is variously known as a transport truck, semi-trailer truck, tractor-trailer truck, semi-tractor truck, semi-truck, trailer truck, tractor truck, transfer truck, articulated truck, artic, single truck, semi-tractor-trailer, semi-trailer, tractor-trailer, semi-tractor, semi, trailer, tractor, big rig, eighteen-wheeler, or articulated lorry, depending on the country and region.

Semi-trailers comprise landing gear that allow for the raising, lowering and support of the forward end or nose portion of the trailer in the engagement and disengagement from the tractor unit (also called a prime mover) and allows the trailer to be freestanding when not in transit. In most instances, the trailer itself is decoupled from a prime mover and then re-coupled to either the same prime mover, a different prime mover, a shunt truck, a converter dolly etc., depending on the logistics appropriate to the use.

A typical scenario is where a trailer is delivered to a loading dock for loading or unloading. The prime mover positions the trailer in the loading dock. The operator will de-latch the kingpin from the fifth wheel (alternatively known as the turntable) and disconnect the service lines. The operator will then manually lower the legs of the landing gear. The operator will then raise the forward end of the trailer to clear the trailer king pin from the fifth wheel of the prime mover. Once the trailer king pin is clear of the prime mover fifth wheel, the prime mover can be driven clear of the trailer to leave the trailer freestanding. The prime mover is then typically utilized elsewhere in a more productive role than being idle while the trailer is loaded or unloaded. The trailer will then be loaded or unloaded, which may take a portion of an hour or it may take several days. The trailer will typically be loaded up to twenty tons in weight, and in some instances up to twenty-five tons, on one trailer. Once the trailer is loaded or unloaded, a prime mover will then return to the trailer for removal of the trailer from the loading dock.

During loading and unloading operations, a rear end of a trailer will typically abut against a dock seal surrounding a doorway of the warehouse from or to which the load is conveyed, such as by a forklift. A lower end of the rear end of the trailer will also abut against loading dock bumpers, which serve to cushion the trailer and an exterior warehouse wall when the weight of the trailer is applied to the loading dock.

With current stationary loading dock bumpers, the vertical movement of a trailer during the loading and unloading of freight may result in increased friction between the rear end of the trailer and the loading dock bumpers, which in turn may result in damage to the trailer and/or the bumpers, requiring repair to the trailer and/or replacement of entire bumper assemblies.

Furthermore, current bumpers that permit some degree of vertical movement comprise springs for biasing the bumpers upwards. Such springs are substantially exposed to the external environment, which may accelerate the wear of the springs through exposure to environmental elements, such as dirt, rain, snow, and/or sleet. Further still, such springs are attached to the mounting plates of the bumpers, necessitating the replacement of an entire bumper assembly, including its mounting plate, when the spring and bumper become worn.

Yet a further issue with current loading dock bumpers is that the bumpers are installed in substantially parallel relation with the loading dock wall to which they are mounted. This arrangement results in reduced contact between the rear end of a trailer and the bumpers when the trailer is at an angle with respect to the bumpers (such as where the loading dock is declined), which in turn increases the amount of force at the point of contact and may result in accelerated wear of the bumper, spring and/or mounting apparatus. Reduced contact may also result where the surface to which the bumpers are installed are located such that the bumpers do not reach, or do not make sufficient contact with, the rear end of a trailer when the trailer is in contact with the loading dock, such that the effectiveness of the bumper is reduced, which may result in damage to the trailer rear end upon contact with the dock and/or during loading and unloading operations.

There is a need for a bumper apparatus that substantially encloses a biasing mechanism and which permits the replacement of a bumper and/or biasing mechanism without the need to replace a mounting structure. There is also a need for a bumper apparatus that is capable of maintaining substantial contact with a trailer rear end, when the trailer is at an angle relative to a loading dock external wall when in contact with the loading dock. Furthermore, there is the need for a bumper apparatus that is capable of mounting a bumper at various distances from a mounting surface.

### SUMMARY

The presently described subject-matter may overcome the disadvantages of, and problems associated with, prior art bumpers, including slidable loading dock bumpers.

In accordance with an aspect, there is provided a bumper apparatus for engaging a transport vehicle at a loading dock, the bumper apparatus comprising: a mounting structure for mounting to the loading dock, a bumper assembly comprising a resilient bumper for engaging the transport vehicle, a mount engagement structure for engaging the mounting structure, and a biasing mechanism for biasing the bumper assembly in a longitudinal position relative to the mounting structure when the mount engagement structure is engaged 10) with the mounting structure, wherein the mount engagement structure comprises a pair of guide channels in which are received flanges of the mounting structure to guide movement of the mount engagement structure in a longitudinal direction relative to the mounting structure, wherein when the mount engagement structure is engaged with the mounting structure, the bumper assembly is longitudinally moveable relative to the mounting structure from an unbiased neutral position, when no unbalanced external force is applied at least partially longitudinally to the bumper assembly, to a biased position in response to an unbalanced external force applied at least partially longitudinally to the bumper assembly, and wherein when the bumper assembly is acted upon by unbalanced external force applied at least partially longitudinally to the bumper assembly to longitudinally move the bumper assembly relative to the mounting structure, the biasing mechanism biases the bumper assembly toward the neutral position.

In an embodiment, the guide channels are of greater width than the thickness of the flanges so that the mount engagement structure can move longitudinally relative to the mounting structure.

In an embodiment, the mount engagement structure is moveable relative to the mounting structure when the resilient bumper is engaged by the transport vehicle at the loading dock.

In an embodiment, the mount engagement structure is engaged with the mounting structure, which facilitates longitudinal movement of the mount engagement structure relative to the mounting structure.

In an embodiment, the biasing mechanism is mounted to the mount engagement structure and the mounting structure comprises a biasing mechanism retaining structure attached generally to a bottom end of the mounting structure.

In accordance with an aspect, there is provided a bumper apparatus for use on loading docks, the apparatus comprising: a mounting structure adapted to be mounted to a wall of the dock; a mount engagement structure slidingly retained on the mounting structure and adapted to have a bumper secured thereto; and a biasing mechanism to bias the mount engagement structure to a predetermined position relative to the mounting structure.

In an embodiment, the mount engagement structure is adapted to slide along the longitudinal axis of the apparatus with respect to the mounting structure.

In an embodiment, the longitudinal axis is orientated substantially vertical.

In an embodiment, the biasing mechanism is contained within the apparatus such that it is not exposed, or susceptible to damage from a vehicle approaching the apparatus.

In an embodiment, wherein the biasing mechanism is contained between the mounting structure and the mount engagement structure.

In an embodiment, the biasing mechanism is received between the mount engagement structure and the mounting structure.

In an embodiment, the biasing mechanism is contained within a void defined by the mounting structure and the mount engagement structure when assembled together.

In an embodiment, at least one recess in the mount engagement structure cooperates with at least one recess in the mounting structure to define the void, when assembled together.

In an embodiment, each recess of the at least one recess in the mount engagement structure and each recess of the at least one recess in the mounting structure is substantially parallel with the longitudinal axis of the apparatus.

In an embodiment, each recess of the at least one recess in the mount engagement structure extends along at least a portion of mounting structure and each recess of the at least one recess in the mount engagement structure extends along at least a portion of the mount engagement structure.

In an embodiment, one recess of the mounting structure or one recess of the mount engagement structure has at least a partial end wall at, at least one end.

In an embodiment, the at least partial end wall forms a biasing mechanism retaining structure.

In an embodiment, the mounting structure has one recess.

In an embodiment, the one recess of the mounting structure is located along the central longitudinal axis of the mounting structure.

In an embodiment, the mounting structure comprises at least one protrusion projecting generally orthogonally from the engagement side of the mounting structure which cooperates with the mount engagement structure when assembled together.

In an embodiment, the mounting structure comprises two spaced-apart protrusions, a first protrusion and a second protrusion, projecting generally orthogonally from the engagement side of the mounting structure which cooperate with the mount engagement structure when assembled together.

In an embodiment, the two spaced-apart protrusions of the mounting structure are located along the longitudinal axis.

In an embodiment, the space between the two spaced-apart protrusions of the mounting structure form the one recess of the mounting structure.

In an embodiment, the mount engagement structure has three recesses, a first recess, a second recess and a third recess.

In an embodiment, the second recess of the mount engagement structure is located along the longitudinal central axis and the first and third recesses are located on opposed sides of the second recess.

In an embodiment, the second recess in the mount engagement structure cooperates with the recess in the mounting structure to define the void, when assembled together.

In an embodiment, the mount engagement structure comprises a plate member and two spaced-apart side walls, a first side wall and a second side wall, projecting generally orthogonally from the plate member.

In an embodiment, the two-spaced apart side walls of the mount engagement structure are two longitudinal arms, a first longitudinal arm and a second longitudinal arm.

In an embodiment, an outer face of the plate member supports the bumper.

In an embodiment, the mount engagement structure comprises a biasing mechanism retention structure.

In an embodiment, the biasing mechanism retention structure is located along the longitudinal central axis of the mount engagement structure.

In an embodiment, the biasing mechanism retention structure forms the second recess in the mount engagement structure.

In an embodiment, the biasing mechanism retention structure is in the form of at least a partial housing for the biasing mechanism.

In an embodiment, the at least partial housing for the biasing mechanism is configured to surround the biasing mechanism on at least three sides, the at least three sides including an opposite side configured to be disposed opposite the outwardly directed surface of the mounting structure.

In an embodiment, the biasing retention structure forms a recess or channel to accommodate the biasing mechanism.

In an embodiment, the biasing mechanism retention structure cooperates with the recess in the mounting structure to define the void, when assembled together.

In an embodiment, the space between the first side wall and the biasing mechanism retention structure form the first recess in the mount engagement structure and the space between the second side wall and the biasing mechanism retention structure form the third recess in the mount engagement structure.

In an embodiment, the second recess in the mount engagement structure is located along the longitudinal central axis and the first and third recesses are located on opposed sides of the second recess.

In an embodiment, the first and third recesses in the mount engagement structure form first and third channels (also referred to herein as guide channels, tracks, guide tracks, slots or keyways), which incorporate and cooperate with the first and second protrusions, respectively of the mounting structure, when the mount engagement structure and the mounting structure are assembled.

In an embodiment, the mounting structure comprises a retaining mechanism for retaining the mount engagement structure in cooperation with the mounting structure, when assembled together.

In an embodiment, the mount engagement structure comprises a retaining mechanism for retaining the mount engagement structure in cooperation with the mounting structure, when assembled together.

In an embodiment, the mount engagement structure retaining mechanism cooperates with the mounting structure retaining mechanism to retain the mount engagement structure in cooperation with the mounting structure, when assembled together.

In an embodiment, the retaining mechanism of the mounting structure comprises a projection extending generally orthogonally from the at least one protrusion.

In an embodiment, the retaining mechanism of the mounting structure comprises two projections, a first projection extending generally orthogonally from the outer surface of the first protrusion and a second projection extending generally orthogonally from the outer surface of the second protrusion.

In an embodiment, the two projections of the mounting structure retaining mechanism are two longitudinal slide guides, a first longitudinal slide guide on the first protrusion and a second longitudinal slide guide on the second protrusion.

In an embodiment, the retaining mechanism of the mount engagement structure comprises two projections, a first projection extending generally orthogonally from the inner surface of the first side wall and a second projection extending generally orthogonally from the inner surface of the second side wall.

In an embodiment, the two projections of the mount engagement structure retaining mechanism are two longitudinal tabs, a first long longitudinal tab on the first longitudinal arm and a second longitudinal tab on the second longitudinal arm.

In an embodiment, the first longitudinal tab cooperates with the first longitudinal slide guide and the second longitudinal tab cooperates with the second longitudinal slide guide, when the mount engagement structure and the mounting structure are assembled.

In accordance with an aspect, there is a provided a loading dock bumper apparatus comprising a mounting structure for securing to a loading dock and a bumper assembly mounted on the mounting structure and arranged to slide in a generally vertical direction relative to the mounting structure.

In an embodiment, one of the bumper assembly and mounting structure comprises at least one channel and the other of the bumper assembly and mounting structure comprises at least one formation arranged to locate in the channel and slide relative thereto to thereby mount the bumper assembly on the mounting structure.

In an embodiment, the at least one channel is defined by a base and opposed sidewalls, at least one of the sidewalls is provided with an inwardly extending limb located in spaced relation to the base, the sidewalls and limb restrain the at least one formation from moving in a direction other than along the length of the channel.

In an embodiment, the at least one channel is defined by at least one channel member projecting from a front face of the mounting structure or a rear face of the bumper assembly.

In an embodiment, the at least one channel is defined by the bumper assembly or the mounting structure.

In an embodiment, the at least one channel comprises a generally U- or C-shaped slot extending between upper and lower edges of the bumper assembly or mounting structure.

In an embodiment, the bumper assembly comprises a shock absorbing body and a mount engagement structure.

In an embodiment, the shock absorbing body is a resilient bumper.

In an embodiment, a biasing mechanism is provided to resiliently bias the bumper assembly to a rest position above the lowest point of its range of vertical movement, such that the bumper assembly may move upward or downward as the height of a vehicle located in the loading dock rises or falls under varying loads.

In an embodiment, the biasing mechanism urges the bumper assembly to a position approximately half way up the range of movement.

In an embodiment, the biasing mechanism comprises a spring arrangement.

In an embodiment, the mounting structure comprises one or more fixing holes formed therein and through which a bolt or like fastener locates to secure the mounting structure to the loading dock.

In accordance with an aspect, there is provided a loading dock bumper apparatus comprising a mounting structure provided with a mounting surface to allow it to be secured to the loading dock; a mount engagement structure arranged to slide in a generally vertical direction relative to the mounting structure, a bumper mounted on the mount engagement structure; and a biasing mechanism provided to resiliently bias the mount engagement structure and bumper to a rest position above the lowest point of its range of vertical movement, such that the mount engagement support and bumper may move upward or downward as the height of a vehicle located in the loading dock rises or falls under varying loads.

In an embodiment, one of the mount engagement structure and mounting structure defines at least one track or channel and the other of the mount engagement structure and mounting structure includes at least one formation arranged to locate in the track or channel and slide relative thereto to thereby mount the mount engagement structure on the mounting structure.

In an embodiment, the at least one track or channel is defined by a base and opposed sidewalls, at least one of the sidewalls is provided with an outwardly extending limb located in spaced relation to the base, the sidewalls and limb restrain the at least one formation from moving in a direction other than along the length of the channel.

In an embodiment, the at least one track or channel is defined by at least one channel member projecting from an inner face of the mount engagement structure.

In an embodiment, the at least one track or channel is defined by the mount engagement structure.

In an embodiment, the at least one track or channel comprises a U- or C-shaped slot extending between upper and lower edges of the mount engagement structure.

In an embodiment, the bumper apparatus comprises a shock absorbing body secured to a plate member of the mount engagement structure.

In an embodiment, the biasing mechanism urges the mount engagement structure to a position approximately half way up the range of movement.

In an embodiment, the biasing mechanism comprises a spring arrangement.

In accordance with an aspect, there is provided a bumper apparatus comprising: a mounting structure attachable to a surface on a mounting side of the mounting structure; and a bumper assembly slidably and removably engaged with an engagement side of the mounting structure opposite the mounting side; the mounting structure comprising a bumper assembly engagement structure extending longitudinally along the mounting structure, the bumper assembly engagement structure for said slidable engagement with the removeable bumper assembly, the bumper assembly slidable longitudinally along the bumper assembly engagement structure, and the bumper assembly engagement structure substantially retaining the bumper assembly laterally with respect to, and against, the mounting structure, the mounting structure comprising a biasing mechanism retaining structure attached generally to a bottom end of the mounting structure; the removeable bumper assembly comprising: a mount engagement structure, a resilient bumper attached to the mount engagement structure, and a biasing mechanism, the mount engagement structure for said longitudinal slidable engagement with the bumper assembly engagement structure, the mount engagement structure comprising a biasing mechanism retention structure for retention of the biasing mechanism; wherein, when the removable bumper assembly is longitudinally slidably engaged with the mounting structure and the mounting structure is attached to a generally vertical surface, the removeable bumper assembly rests upon the biasing mechanism retaining structure in a neutral position when no unbalanced external force is applied at least partially longitudinally to the bumper assembly; wherein, when the removeable bumper assembly is acted upon by said unbalanced external force applied at least partially longitudinally to the bumper assembly toward said biasing mechanism retaining structure to move said removeable bumper assembly into a lowered position, the biasing mechanism biases the removeable bumper assembly upward, away from the biasing mechanism retaining structure toward the neutral position of the removeable bumper assembly.

In an embodiment, the biasing mechanism comprises one or more compression springs.

In an embodiment, the biasing mechanism comprises one of said one or more compression springs.

In an embodiment, the biasing mechanism retention structure comprises a channel formed longitudinally within the mount engagement structure, and a rod extending through a longitudinal axis of the compression spring, the rod comprising terminating plates attached to opposite ends thereof, the compression spring situated between the terminating plates, the compression spring, the rod and the terminating plates comprising a compression spring assembly, the terminating plates preventing movement of the compression spring off of the rod, the biasing mechanism retention structure further comprising a cap attached atop the biasing mechanism and the channel, to the channel and about the rod such that the rod passes through the cap, such that downward movement of the bumper assembly causes downward movement of the cap to thereby compress the compression spring, the compression spring compressed through contact of an upper end of the compression spring against the cap and a lower end of the compression spring assembly against the biasing mechanism retaining structure.

In an embodiment, the lower end of the compression spring assembly abuts against the biasing mechanism retaining structure when the removable bumper assembly is in the neutral position or the lowered position.

In an embodiment, the cap, the channel and the mounting structure together substantially enclose the biasing mechanism when the removable bumper assembly is in the neutral position or the lowered position.

In an embodiment, when: the removable bumper assembly is longitudinally slidably engaged with the mounting structure and the mounting structure is attached to the generally vertical surface, and a load is applied against the resilient bumper toward the generally vertical surface, a force of the applied load is distributed from the mount engagement structure to the mounting structure through at least four points of contact therebetween.

In an embodiment, the at least four points of contact are generally evenly distributed across a width of the mount engagement structure.

In an embodiment, when: the removable bumper assembly is longitudinally slidably engaged with the mounting structure and the mounting structure is attached to the generally vertical surface, and no load is applied against the resilient bumper toward the generally vertical surface, tolerances of the mount engagement structure and the mounting structure are such that the removeable bumper assembly can be slid relative to the mounting structure with no or minimal friction between the mount engagement structure and the mounting structure.

In an embodiment, the mount engagement structure is formed from a first metal and the mounting structure if formed from a second metal, the first metal being softer than the second metal.

In an embodiment, the first metal comprises aluminum and the second metal comprises steel.

In an embodiment, the mounting structure is rightwardly offset, leftwardly offset, or centrally disposed with respect to the slidably engaged removeable bumper assembly.

In an embodiment, the bumper apparatus further comprises a tilt assembly comprising: a baseplate; and a tilt frame pivotally attached to the baseplate, the tilt frame being fixable in angled relation to the baseplate; wherein, in use: the tilt frame is fixed in said angled relation to the baseplate; the surface to which the mounting structure is attachable comprises a surface of the tilt frame, such that the mounting structure, attached to the surface, is in said angled relation relative to the baseplate; and the bumper apparatus is attached to another surface via an attachment end of the baseplate, such that the removeable bumper assembly is in said angled relation relative to the another surface, the tilt assembly spacing the mounting structure from the another surface by a distance.

In an embodiment, the baseplate is rightwardly offset, leftwardly offset, or centrally disposed with respect to the slidably engaged removeable bumper assembly.

In an embodiment, the bumper apparatus as described above further comprises an extension apparatus, wherein, in use, the surface to which the mounting structure is attachable comprises a surface of said extension apparatus, and the extension apparatus is attached to another surface via an attachment end thereof, the extension apparatus spacing the mounting structure from the another surface.

In an embodiment, the extension apparatus attachment end is rightwardly offset, leftwardly offset, or centrally disposed with respect to the slidably engaged removeable bumper assembly.

In an embodiment, the baseplate comprises a tilt frame support surface and a baseplate spacing structure extending opposite the mounting structure from the tilt frame support surface, wherein, in use, when the bumper apparatus is attached to said another surface via the baseplate attachment end, the baseplate spacing structure spaces the mounting structure from the another surface by a further distance, beyond the distance.

In an embodiment, the baseplate attachment end is rightwardly offset, leftwardly offset, or centrally disposed with respect to the slidably engaged removeable bumper assembly.

In an embodiment, the tilt assembly comprises steel.

In an embodiment, the extension apparatus comprises steel.

In accordance with an aspect, there is provided bumper apparatus comprising: a mounting structure attachable to a surface, and a bumper assembly slidably and removably engaged with the mounting structure; the mounting structure comprising a bumper assembly engagement structure; the bumper assembly comprising: a mount engagement structure for longitudinal slidable engagement with the bumper assembly engagement structure, a resilient bumper attached to the mount engagement structure, and a biasing mechanism; wherein, in use: the removeable bumper assembly rests upon a biasing mechanism retaining structure attached generally to a bottom end of the mounting structure, in a neutral position when no unbalanced external force is applied at least partially longitudinally to the bumper assembly; and when the removeable bumper assembly is acted upon by said unbalanced external force applied at least partially longitudinally to the bumper assembly toward the biasing mechanism retaining structure to move the bumper assembly into a lowered position, the biasing mechanism biases the bumper assembly upward, toward the neutral position.

In accordance with an aspect, there is provided a bumper apparatus comprising: a mounting structure adapted to be attached to a surface of a support structure, the mounting structure defining an outwardly directed surface relative to the support surface; a bumper assembly defining surfaces both inwardly and outwardly directed relative to the support surface, the outwardly directed surface of the bumper assembly defining a resilient bumper and the inwardly directed surface of the bumper assembly mounted on the outwardly directed surface of the mounting structure and guided there along for vertical sliding movement relative thereto; wherein the inwardly directed surface of the bumper assembly defines at least a partial housing for a biasing mechanism co-acting with, and adapted to resist downwardly directed sliding movement of, the bumper assembly relative to the mounting structure.

In an embodiment, the biasing mechanism comprises a spring guide element upon which a spring is disposed, the at least partial housing having a top end against which a top end of the spring engages, wherein a transverse abutment extends from the outwardly directed surface of the mounting structure against which a bottom end of the spring engages, and whereby any downwards movement of the bumper assembly causes simultaneous downward movement of the top end of the at least partial housing, the spring on the spring guide element and thereby compression of the spring.

In an embodiment, the bumper assembly will slide downwards relative to the mounting structure under the influence of an external downwards force applied thereto and then return to its at rest position when the force is removed.

In an embodiment, the spring guide element is a rigid element.

In an embodiment, the spring guide element is a rod.

In an embodiment, the inwardly directed surface of the bumper assembly defines an inwardly projecting channel.

In an embodiment, the inwardly projecting channel has inwardly directed surfaces defining the at least partial housing for the biasing mechanism.

In an embodiment, the outwardly directed surface of the mounting structure defines an outwardly projecting vertical guide rail.

In an embodiment, the bumper assembly comprises a slotted keyway extending along its inwardly directed face, the vertical guide rail extending within the slotted keyway and the slotted keyway slidably engaging with the outwardly projecting vertical guide rail.

In an embodiment, the keyway extends between top and bottom ends of the bumper assembly and the guide rail has a length which approximates the length of keyway, and wherein the abutment is located adjacent the lower end of the guide rail.

In an embodiment, the inwardly directed surface of the bumper assembly defines a recessed vertical guide channel, and the mounting structure comprises a projection of matching shape extending from the outwardly directed surface thereof, so that the recessed vertical guide channel may slide up and down the projection and be slidably retained by the projection.

In an embodiment, the recessed vertical guide channel and a second recessed vertical guide channel are disposed to either side of the at least partial housing and the projection and a second projection of matching shape extends from the outwardly directed surface thereof, so that the second recessed vertical guide channel may slide up and down the second projection and wherein the abutment is located between the projection and the second projection adjacent the lower end thereof.

In an aspect, there is provided a loading dock bumper assembly incorporating a pair of bumper apparatuses, each bumper apparatus comprising a mounting structure configured to be attached to a surface of a support structure, the mounting structure defining an outwardly directed surface relative to the support surface, a bumper assembly defining surfaces both inwardly and outwardly directed relative to the support surface, the inwardly directed surface of the bumper assembly mounted on the outwardly directed surface of the mounting surface and guided there along for vertical sliding movement relative thereto, the inwardly directed surface of the bumper assembly defining a housing for a biasing mechanism co-acting with, and adapted to resist downwardly directed sliding movement of, the bumper assembly relative to the mounting structure.

### BRIEF DESCRIPTION OF THE DRAWINGS

Aspects of presently described subject-matter will now be described by way of example only, with reference to the Figures, in which:

FIG. 1 is a front isometric view of a bumper apparatus;

FIG. 1A is a rear isometric view of a bumper assembly of the bumper apparatus shown in FIG. 1;

FIG. 1B is a front isometric view of a mounting structure of the bumper apparatus shown in FIG. 1;

FIG. 1C is a front isometric view of the bumper apparatus shown in FIG. 1 with the bumper assembly in a lowered position;

FIG. 1D is a rear isometric view of the bumper apparatus shown in FIG. 1C;

FIG. 1E is a front isometric view of the bumper apparatus shown in FIG. 1C with certain components of the bumper assembly removed to show the compression spring in a compressed configuration;

FIG. 1F is a front isometric view of the bumper apparatus shown in FIG. 1 with the bumper assembly in a raised position;

FIG. 1G is a rear isometric view of the bumper apparatus shown in FIG. 1F;

FIG. 2 is a top view of the bumper apparatus shown in FIG. 1;

FIG. 3 is a bottom view of the bumper apparatus shown in FIG. 1;

FIG. 4 is a rear view of the bumper apparatus shown in FIG. 1;

FIG. 5 is a front isometric view of the bumper apparatus shown in FIG. 1 with the bumper removed;

FIG. 6 is a front isometric view of the bumper apparatus shown in FIG. 5 with the bumper mounting apparatus removed;

FIG. 7 is a front isometric view of the bumper apparatus shown in FIG. 6 with the mounting structure removed;

FIG. 8 is a rear isometric view of the bumper apparatus shown in FIG. 7;

FIG. 9 is a partial rear isometric view of the bumper apparatus shown in FIG. 8 with the cap and the upper terminating plate removed;

FIG. 10 is a top view of another embodiment of a bumper apparatus, showing no contact between the mounting structure and the removeable bumper assembly;

FIG. 11 is a front isometric view of a tilt assembly;

FIG. 12 is a front view of the tilt assembly shown in FIG. 11;

FIG. 13 is a bottom view of the tilt assembly shown in FIG. 11;

FIG. 14 is a side view of the tilt assembly shown in FIG. 11;

FIG. 15 is a rear isometric view of a bumper apparatus comprising a tilt assembly;

FIG. 16 is a side view of the bumper apparatus comprising a tilt assembly shown in FIG. 15;

FIG. 17 is a top view of the bumper apparatus comprising a tilt assembly shown in FIG. 15;

FIG. 18 is a bottom view of the bumper apparatus comprising a tilt assembly shown in FIG. 15;

FIG. 19 is a side view of the bumper apparatus comprising a tilt assembly shown in FIG. 15, showing the tilt frame at an angle relative to the baseplate;

FIG. 20 is a front isometric view of a bumper apparatus comprising an extension apparatus;

FIG. 21 is a rear isometric view of the bumper apparatus comprising an extension apparatus shown in FIG. 20;

FIG. 22 is a top view of the bumper apparatus comprising an extension apparatus shown in FIG. 20;

FIG. 23 is a bottom view of the bumper apparatus comprising an extension apparatus shown in FIG. 20;

FIG. 24 is a front isometric view of a bumper apparatus comprising a tilt assembly comprising a baseplate spacing structure;

FIG. 25 is a top view of the bumper apparatus comprising a tilt assembly comprising a baseplate spacing structure shown in FIG. 24;

FIG. 26 is a rear isometric view of the bumper apparatus comprising a tilt assembly comprising a baseplate spacing structure shown in FIG. 24;

FIG. 27A is a front isometric view of a bumper apparatus comprising a centrally disposed mounting structure;

FIG. 27B is a front isometric view of a bumper apparatus comprising a leftwardly offset mounting structure;

FIG. 27C is a front isometric view of a bumper apparatus comprising a rightwardly offset mounting structure;

FIG. 27D is a front isometric view of a bumper apparatus comprising another embodiment of a centrally disposed mounting structure;

FIG. 28A is a front isometric view of a bumper apparatus comprising an extension apparatus and a centrally disposed extension apparatus attachment end;

FIG. 28B is a front isometric view of a bumper apparatus comprising an extension apparatus and a leftwardly offset extension apparatus attachment end;

FIG. 28C is a front isometric view of a bumper apparatus comprising an extension apparatus and a rightwardly offset extension apparatus attachment end;

FIG. 28D is a front isometric view of a bumper apparatus comprising an extension apparatus and another embodiment of a centrally disposed extension apparatus attachment end;

FIG. 29A is a front isometric view of a bumper apparatus comprising a tilt assembly and a centrally disposed baseplate;

FIG. 29B is a front isometric view of a bumper apparatus comprising a tilt assembly and a rightwardly offset baseplate;

FIG. 29C is a front isometric view of a bumper apparatus comprising a tilt assembly and a leftwardly offset baseplate;

FIG. 29D is a front isometric view of a bumper apparatus comprising a tilt assembly and another embodiment of a centrally disposed baseplate;

FIG. 30A is a front isometric view of a bumper apparatus comprising a tilt assembly comprising a baseplate spacing structure and a centrally disposed baseplate attachment end;

FIG. 30B is a front isometric view of a bumper apparatus comprising a tilt assembly comprising a baseplate spacing structure and a rightwardly offset baseplate attachment end;

FIG. 30C is a front isometric view of a bumper apparatus comprising a tilt assembly comprising a baseplate spacing structure and a leftwardly offset baseplate attachment end;

FIG. 30D is a front isometric view of a bumper apparatus comprising a tilt assembly comprising a baseplate spacing structure and another embodiment of a centrally disposed baseplate attachment end;

FIG. 31A is a top view of a bumper apparatus comprising an extension apparatus and a centrally disposed extension apparatus attachment end;

FIG. 31B is a top view of a bumper apparatus comprising an extension apparatus and a leftwardly offset extension apparatus attachment end;

FIG. 31C is a top view of a bumper apparatus comprising an extension apparatus and a rightwardly offset extension apparatus attachment end;

FIG. 31D is a top view of a bumper apparatus comprising an extension apparatus and another embodiment of a centrally disposed extension apparatus attachment end;

FIG. 31E is a top view of a bumper apparatus comprising another embodiment of an extension apparatus, and a centrally disposed extension apparatus attachment end;

FIG. 31F is a top view of a bumper apparatus comprising another embodiment of an extension apparatus, and a leftwardly offset extension apparatus attachment end;

FIG. 31G is a top view of a bumper apparatus comprising another embodiment of an extension apparatus, and a rightwardly offset extension apparatus attachment end;

FIG. 31H is a top view of a bumper apparatus comprising another embodiment of an extension apparatus, and another embodiment of a centrally disposed extension apparatus attachment end;

FIG. 31I is a top view of a bumper apparatus comprising a centrally disposed mounting structure;

FIG. 31J is a top view of a bumper apparatus comprising a leftwardly offset mounting structure;

FIG. 31K is a top view of a bumper apparatus comprising a rightwardly offset mounting structure;

FIG. 31L is a top view of a bumper apparatus comprising another embodiment of a centrally disposed mounting structure;

FIG. 31M is a top view of a bumper apparatus comprising a tilt assembly and a centrally disposed baseplate;

FIG. 31N is a top view of a bumper apparatus comprising a tilt assembly and a leftwardly offset baseplate;

FIG. 31O is a top view of a bumper apparatus comprising a tilt assembly and a rightwardly offset baseplate;

FIG. 31P is a top view of a bumper apparatus comprising a tilt assembly and another embodiment of a centrally disposed baseplate;

FIG. 31Q is a top view of a bumper apparatus comprising a tilt assembly comprising a baseplate spacing structure and a centrally disposed baseplate attachment end;

FIG. 31R is a top view of a bumper apparatus comprising a tilt assembly comprising a baseplate spacing structure and a leftwardly offset baseplate attachment end;

FIG. 31S is a top view of a bumper apparatus comprising a tilt assembly comprising a baseplate spacing structure and a rightwardly offset baseplate attachment end; and

FIG. 31T is a top view of a bumper apparatus comprising a tilt assembly comprising a baseplate spacing structure and another embodiment of a centrally disposed baseplate attachment end.

### FEATURE LIST

10 bumper apparatus
12 mounting structure
13 mount plate of mounting structure 12
14 mounting side of mounting structure 12
16 bumper assembly
18 engagement side of mounting structure 12
20 bumper assembly engagement structure
22 top end of mounting structure 12
24 bottom end of mounting structure 12
26 mount engagement structure of bumper assembly or bumper support frame 16
28 resilient bumper of bumper assembly 16
28a rubber tile
30 biasing mechanism of bumper assembly 16
32 bumper mounting apparatus
32a bolts
32b nuts
32c side plates
32 holes
32e bumper rods
34 nut retention tab
36 longitudinal arms of mount engagement structure 26
38 longitudinal slide guides of bumper assembly engagement structure 20
39 longitudinal protrusions (also referred to herein as projections, formations, guide rails or flanges) projecting generally orthogonally from mounting structure 12
40 longitudinal tabs of longitudinal arms 36 of mount engagement structure 26
42 biasing mechanism retaining structure
44 biasing mechanism retention structure (also referred to herein as an at least partial housing for the biasing mechanism 30)
46 recess or channel formed by the biasing mechanism retention structure 44
48 rod
50 terminating plates
52 compression spring assembly
54 cap
54a attachment means/screws
56 upper end of compression spring 30
58 lower end of compression spring assembly 52
60 cavities
62 points of contact
64 tilt assembly
66 baseplate of tilt assembly 64
66a top end of baseplate 66
68 tilt frame of tilt assembly 64
68a top end of tilt frame 68
70 frame members of tilt frame 68
72 tilting members of tilt frame 68
74 connecting rod
75 nut for connecting rod 74 (when connecting rod comprises a bolt)
76 surface of tilt frame 68
78 attachment end of baseplate 66 of tilt assembly 64
80 distance of mounting structure 12 from the external surface due to tilt assembly 64
82 cross members of tilt frame 68
84 extension apparatus
86 surface of extension apparatus 84
88 attachment end of extension apparatus 84
90 distance of mounting structure 12 from external surface due to extension apparatus 84
92 cross member(s) of extension apparatus 84
94 side members of extension apparatus 84
96 top cap of extension apparatus 84
98 bottom cap of extension apparatus 84
100 tilt frame support surface
102 baseplate spacing structure
104 further distance beyond distance 80
106 side flange of attachment mechanism
108 lower edges of frame members 70 and tilting members 72
110 upper edges of frame members 70 and tilting members 72
112 connections

### DETAILED DESCRIPTION

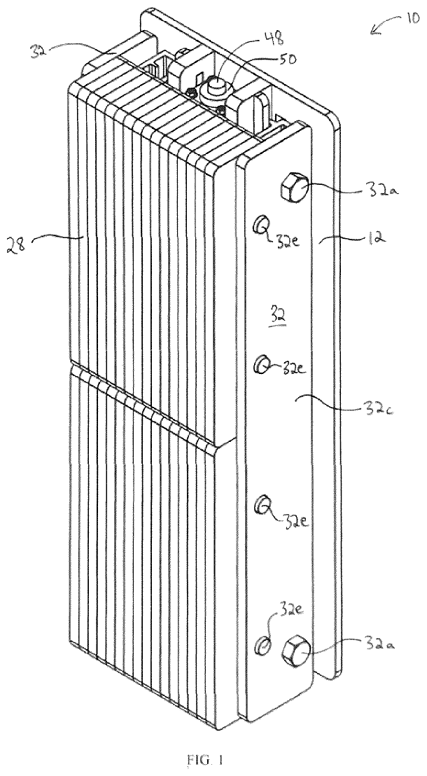

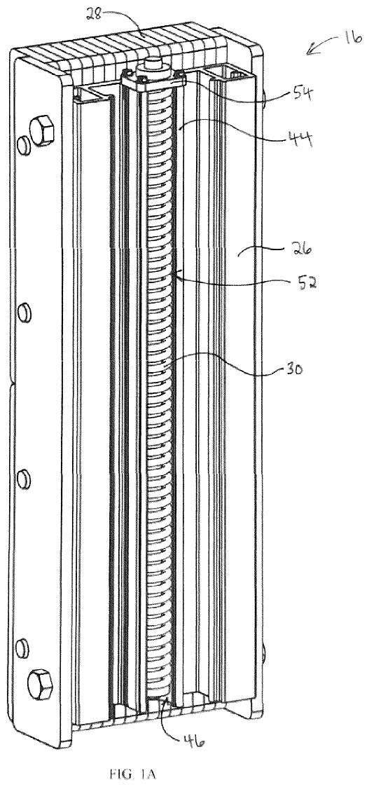

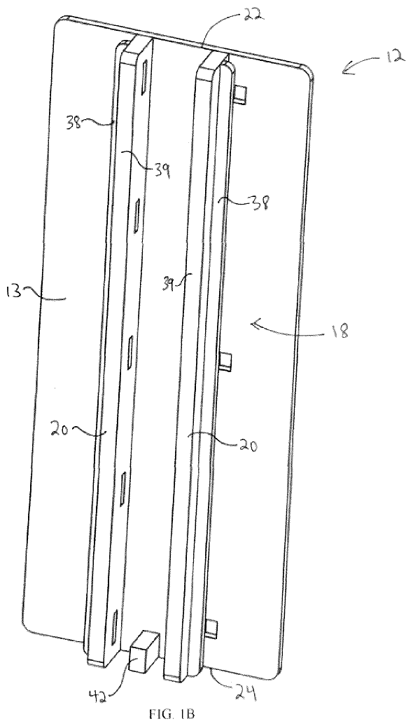

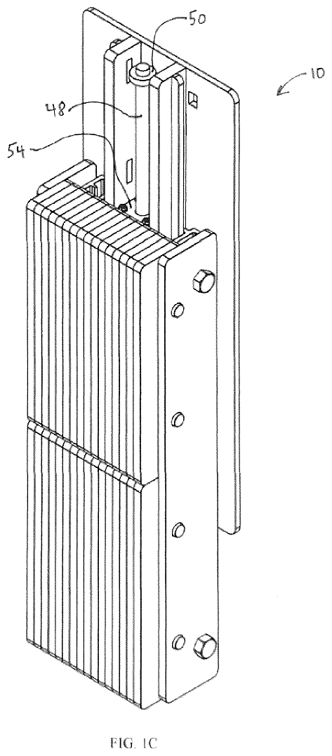

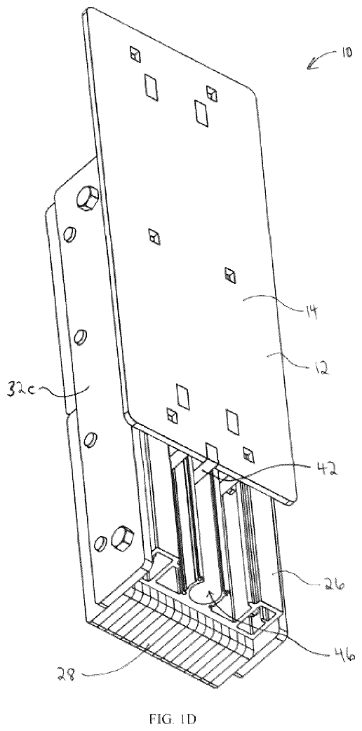

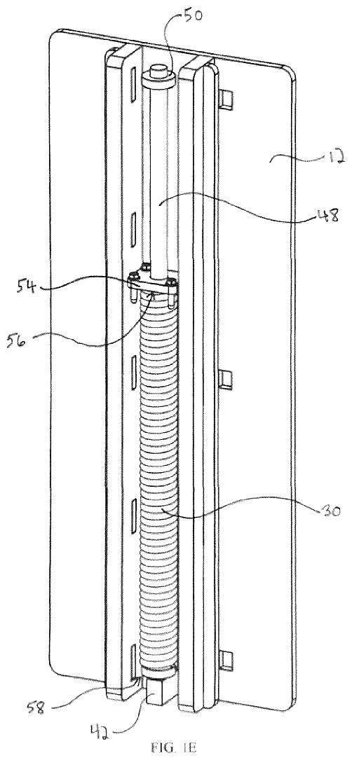

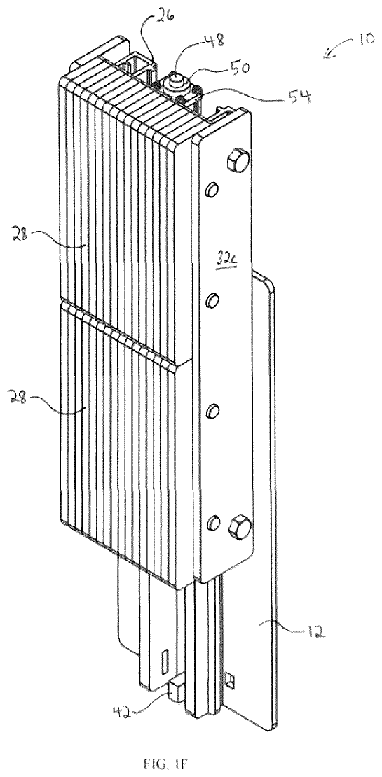

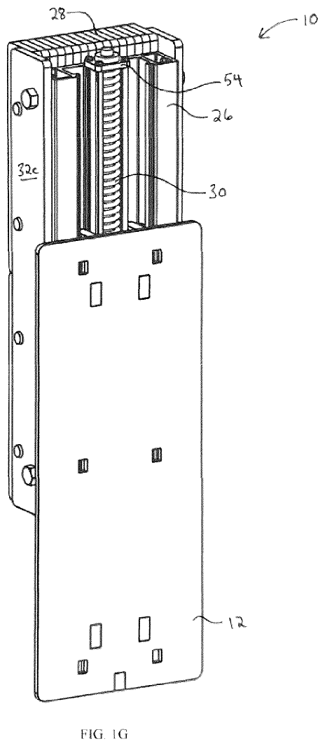

With reference to the drawings and the example embodiments depicted therein, there is shown a bumper apparatus 10, which may comprise a mounting structure 12 (shown in isolation in FIG. 1B) that is attachable to a surface, on a mounting side 14 of the mounting structure 12. The surface may comprise a generally vertical exterior wall of a loading dock, or some other type of surface, such as a wall that is not a loading dock warehouse wall (e.g., where the bumper apparatus is used for some purpose other than a loading dock bumper for a trailer), or the surface of a further component of the bumper apparatus, as discussed further below.

The bumper apparatus 10 may further comprise a bumper assembly 16 (shown in isolation in FIG. 1A) slidably and removably engaged with an engagement side 18 of the mounting structure 12, the engagement side 18 being opposite the mounting side 14 of the mounting structure 12.

The mounting structure 12 may further comprise a bumper assembly engagement structure 20 extending longitudinally along the mounting structure 12, such as generally between a top end 22 and a bottom end 24 of the mounting structure 12 (shown most clearly in FIG. 1B) and projecting, such as orthogonally, from a mount plate 13 (see FIG. 1B) of the mounting structure 12. The bumper assembly engagement structure 20 may slidably engage with the removeable bumper assembly 16 such that the bumper assembly 16 is slidable longitudinally along the bumper assembly engagement structure 20 and the bumper assembly engagement structure 20 substantially retains the bumper assembly 16 laterally with respect to, and against, the mounting structure 12. It will be appreciated that while the bumper assembly engagement structure 20 shown in the Figures extends fully between the top and bottom ends 22, 24 of the mounting structure 12, the bumper assembly engagement structure 20 need not extend the full distance between the top and bottom ends 22, 24 of the mounting structure 12, and may stop short of one or both of the top and bottom ends 22, 24, depending on the extent of slidable engagement required between the bumper assembly 16 and the mounting structure 12.

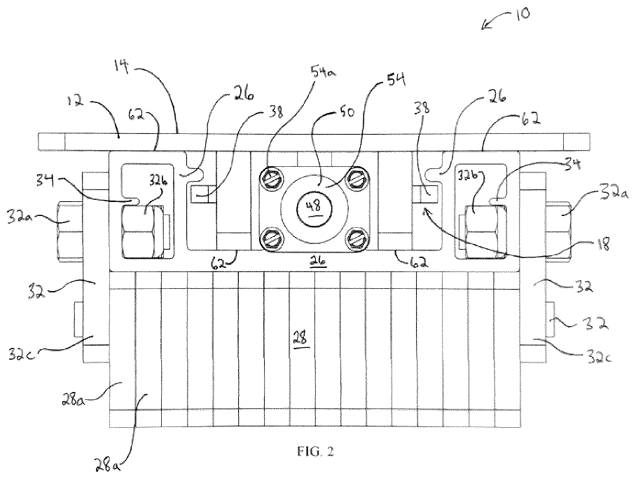

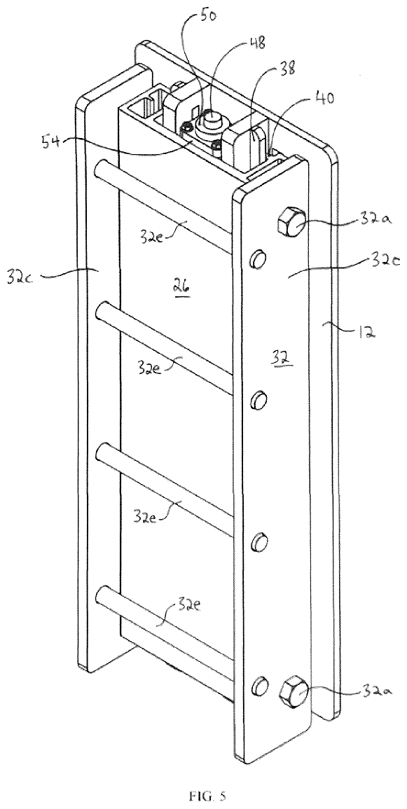

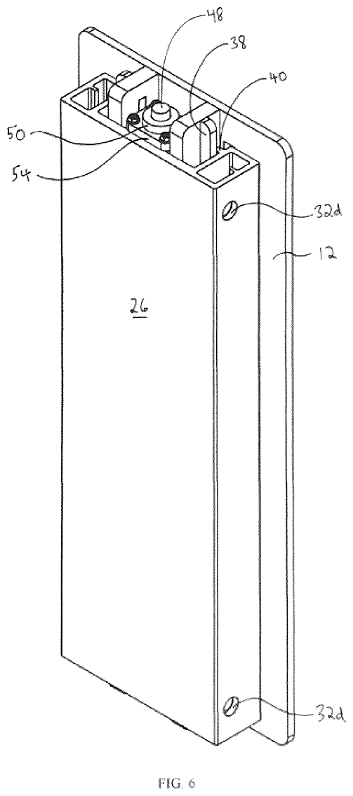

The removeable bumper assembly 16 may comprise a mount engagement structure or bumper support frame 26, a resilient bumper 28 attached to the mount engagement structure 26, and a biasing mechanism 30 (shown most clearly in FIGS. 1A, 8 and 9). The resilient bumper may be formed from any resilient material, such as rubber. Further, each rubber bumper 28 may be formed, for example, from adjacent rubber tiles 28a (see FIG. 2) which may comprise die cut tiles, or a single molded piece of rubber formed from individual ground rubber bits or pellets (as shown in FIG. 10). Each resilient bumper 28 may be attached to the mount engagement structure 26 by a bumper mounting apparatus 32. The bumper mounting apparatus 32 may comprise bolts 32a and nuts 32b for securing side plates 32c against the mount engagement structure 26 to retain the resilient bumper(s) 28 therebetween. The bolts 32a may pass through holes 32d formed in the side plates 32c (not shown) and the mount engagement structure 26 (see FIGS. 6-9). To facilitate manufacture of the bumper apparatus 10, the mount engagement structure 26 may comprise nut retention tabs 34 for preventing each nut 32b from rotating, through contact between the nuts 32b and the respective retention tabs 34, while the bolts 32a are tightened onto the respective side plates 32c.

Frictional engagement between the resilient bumper 28 and the side plates 32c may prevent to some extent the longitudinal movement of the bumper 28 relative to the side plates 32c and the mount engagement structure 26. To further mitigate against, or prevent, such longitudinal movement of the bumper(s) 28 relative to the side plates 32c and the mount engagement structure 26, the bumper mounting apparatus 32 may further comprise one or more bumper rods 32e passing laterally through the bumper(s) 28 and fixedly secured to each side plate 32c, such as by welded connection. As such, during manufacture, each side plate 32c and bumper (e.g., each rubber tile 28a of the bumper(s) 28) may have holes formed therethrough via known means (e.g., drilling). One side plate 32c may then be bolted onto the mount engagement structure 26, and the bumpers 28 may be compressed between the side plates, with the bumper rods 32e passed through holes formed in the side plates 32c and the bumper(s) 28, and the bumper rods 32e may then be welded to the side plates 32c to retain the bumper(s) 28 therebetween.

The mount engagement structure 26 provides for the longitudinal slidable engagement of the bumper assembly 16 with the bumper assembly engagement structure 20 of the mounting structure 12, such as by slidable engagement between the longitudinal arms 36 of the mount engagement structure 26 and the bumper assembly engagement structure 20 of the mounting structure 12. For example, such slidable engagement may be realized through slidable engagement between longitudinal slide guides 38 of the bumper assembly engagement structure 20 of the mounting structure 12, and longitudinal tabs 40 formed on the longitudinal arms 36 of the mount engagement structure 26. The longitudinal slide guides 38 may project (such as generally orthogonally) from longitudinal protrusions 39 that project (such as generally orthogonally) from the mounting structure 12, such that: contact between the longitudinal slide guides 38 and the longitudinal tabs 40 substantially prevent movement of the bumper assembly 16 away from, or retain the bumper assembly 16 against, the mounting structure 12; and contact between the mount engagement structure 26 and the longitudinal slide guides 38 or the longitudinal protrusions 39 substantially retains the bumper assembly 16 laterally with respect to the mounting structure 12.

The mount engagement structure 26 may further comprise a biasing mechanism retention structure 44 for retention of the biasing mechanism 30. As an example, and as shown in FIGS. 1A, 1D and 3, where the biasing mechanism 30 comprises one or more compression springs 30 (such as the single compression spring 30 of the example embodiments shown in the figures), the biasing mechanism retention structure 44 may comprise a channel 46 (see FIGS. 1A and 1D) formed longitudinally within the mount engagement structure 26. In the example embodiments shown in the figures, the channel comprises a longitudinal, arcuate channel dimensioned to substantially enclose the longitudinal cylindrical compression spring 30. It will be appreciated that the biasing mechanism retention structure 44 may comprise any shape or configuration suitable for retaining the biasing mechanism 30, and such would depend on the type and dimension of biasing mechanism used (discussed further below).

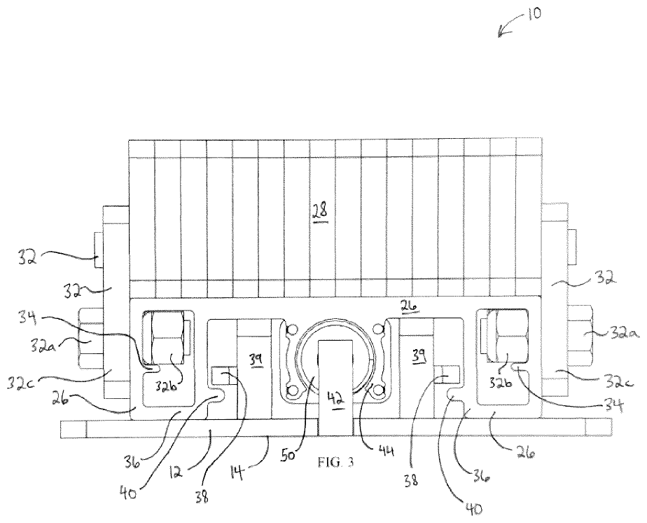

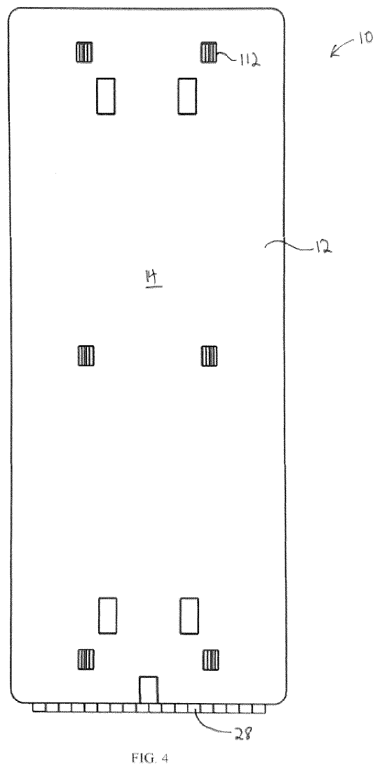

To assemble the bumper apparatus, the bumper assembly 16 may be slid onto the mounting structure 12 such that the longitudinal slide guides 38 of the bumper assembly engagement structure 20 of the mounting structure 12 slidably engage the mount engagement structure 26 of the bumper assembly 16 via the longitudinal tabs 40 formed on the longitudinal arms 36. In order to prevent slidable downward movement of the bumper assembly 16 past a neutral position of the bumper assembly 16 (i.e., when the biasing mechanism 30 is at rest and not acted upon by an external unbalanced force applied at least partially longitudinally thereupon, as shown, e.g., in FIGS. 1 and 4), the mounting structure 12 may further comprise a biasing mechanism retaining structure 42 attached generally to the bottom end of the mounting structure 12 (shown most clearly in FIGS. 1B and 1D-1F), such as by welded connection. When the removable bumper assembly 16 is longitudinally slidably engaged with the mounting structure 12, and the mounting structure 12 is generally vertically positioned (e.g., such as when the mounting structure 12 is attached to a generally vertical surface, such as that of an exterior wall of a loading dock), the removeable bumper assembly 16 will rest upon the biasing mechanism retaining structure 42 in the neutral position (shown in FIG. 1) when no unbalanced external force is applied to the bumper assembly 16 at least partially longitudinally toward the biasing mechanism retaining structure 42.

When the removeable bumper assembly 16 is acted upon by an unbalanced external force applied to the bumper assembly 16 at least partially longitudinally toward the biasing mechanism retaining structure 42, to move the removeable bumper assembly 16 into a lowered position (shown in FIGS. 1C and 1D), the biasing mechanism 30 biases the removeable bumper assembly 16 upward, away from the biasing mechanism retaining structure 42 toward the neutral position of the removeable bumper assembly 16.

Where the biasing mechanism 30 comprises a compression spring, the biasing mechanism retention structure 44 may further comprise a rod 48 extending through a longitudinal axis of the compression spring 30, the rod 48 comprising terminating plates 50 attached to opposite ends of the rod 48, and the compression spring 30 being situated between the terminating plates 50. For ease of reference, the compression spring 30, the rod 48 and the terminating plates 50 comprise a compression spring assembly 52 (see FIG. 1A). The terminating plates 50 may be fixedly attached to the ends of the rod 48, such as by welded connection, and may prevent movement of the compression spring 30 off of the rod 48.

The biasing mechanism retention structure 44 may further comprise a cap 54 attached atop the biasing mechanism 30 and the channel 46 to the mount engagement structure 26, and about the rod 48 such that the rod passes through the cap 54, such as centrally therethrough. The cap 54 may be attached to the mount engagement structure 26, and particularly to the biasing mechanism retention structure 44 thereof, by any known attachment means 54a, such as by the screws 54a shown in the figures. With reference to FIGS. 1C, 1D and 1E, downward movement of the bumper assembly 16 causes downward movement of the cap 54 to thereby compress the compression spring 30 through contact of an upper end 56 of the compression spring 30 against the cap 54 and a lower end 58 of the compression spring assembly 52 against the biasing mechanism retaining structure 42, as most clearly shown in FIG. 1E. In this way, the lower end 58 of the compression spring assembly 52 abuts against the biasing mechanism retaining structure 42 when the removable bumper assembly 16 is in the neutral position (as shown in FIG. 1) or the lowered position (as shown in FIGS. 1C and 1D).

The cap 54, the biasing mechanism retention structure 44 (forming the recess or channel 46) and the mounting structure 12 may together substantially enclose the biasing mechanism 30 when the removable bumper assembly is in the neutral position (as shown in FIG. 1) or the lowered position (as shown in FIGS. 1C and 1D). In this way, it is expected that the bumper apparatus 10 may substantially shield the biasing mechanism 30, such as the spring 30, from external environmental elements, such as dirt, snow, rain, or sleet, as well as from impact by external bodies, such as a trailer making contact with the bumper apparatus 10, which may increase the usable life of the spring, while cavities 60 (see FIG. 17) of the bumper apparatus 10 may allow for such environmental elements to be washed away from other parts of the bumper apparatus 10.

With reference to FIG. 2, in use, when the removable bumper assembly 16 is longitudinally slidably engaged with the mounting structure 12 and the mounting structure 12 is attached to a generally vertical surface, and a load is applied against the resilient bumper(s) 28 toward the surface, a force of the applied load is distributed from: (i) the resilient bumper(s) 28 to the mount engagement structure 26 through substantial abutment therebetween; (ii) the mount engagement structure 26 to the mounting structure 12 through at least four points of contact 62 therebetween; and (iii) the mounting structure 12 to the surface through substantial abutment therebetween. While the surface to which the bumper apparatus 10 is attached or mounted has not been shown in the figures, a description of the means of attachment to the surface is provided further below. As shown in the figures, the four points of contact may be generally evenly distributed across a width of the mount engagement structure 26, which may more evenly distribute an applied force from the bumper assembly 16 to the mounting structure 12.

With reference to FIG. 10, the bumper apparatus 10 may be configured such that when the removable bumper assembly 16 is longitudinally and slidably engaged with the mounting structure 12 and the mounting structure 12 is attached to a generally vertical surface, and no load is applied against the resilient bumper 28 toward the surface to which the bumper apparatus 10 is mounted, tolerances of the mount engagement structure 26 and the mounting structure 12 may be such that the removeable bumper assembly 16 can be slid relative to the mounting structure 12 with no or minimal friction between the mount engagement structure 26 and the mounting structure 12 (FIG. 10 showing no contact between the mount engagement structure 26 and the mounting structure 12). Such tolerances are expected to facilitate removal of the bumper assembly 16 from the mounting structure 12, such as for replacement of the bumper assembly 16.

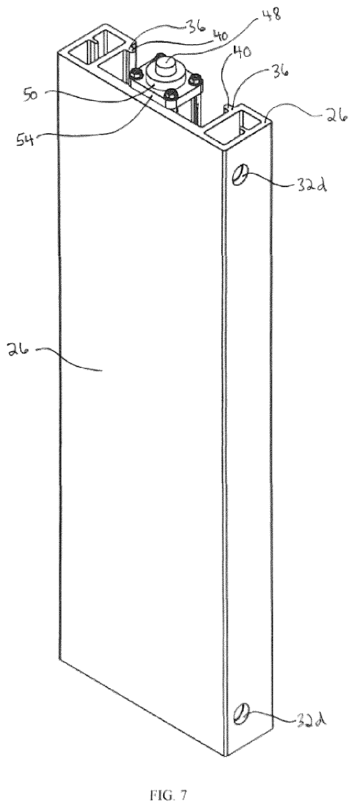

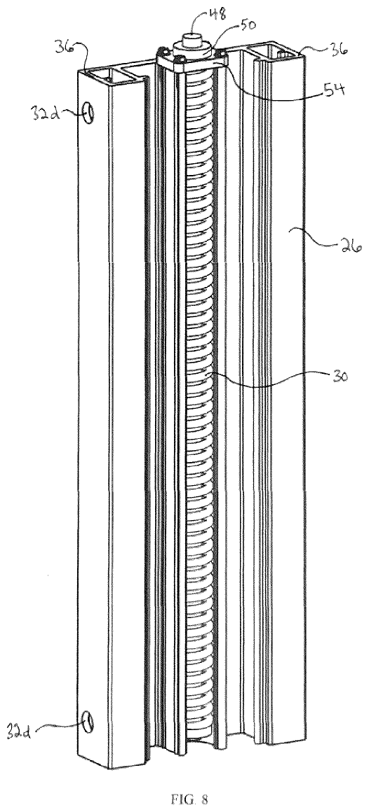

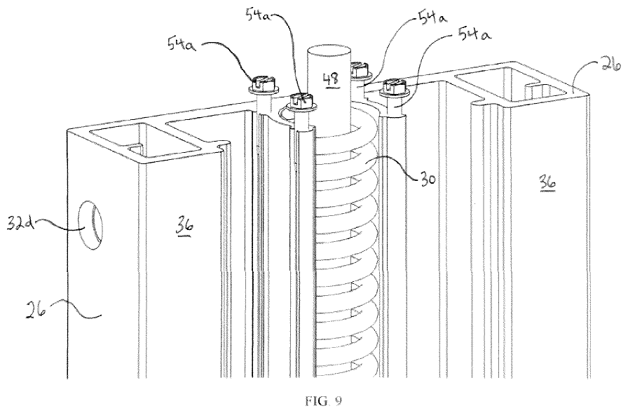

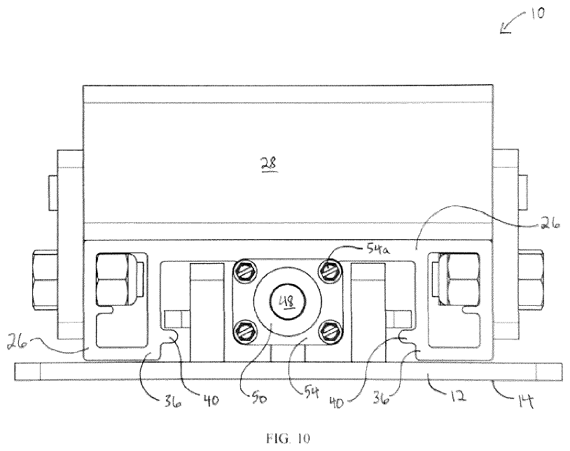

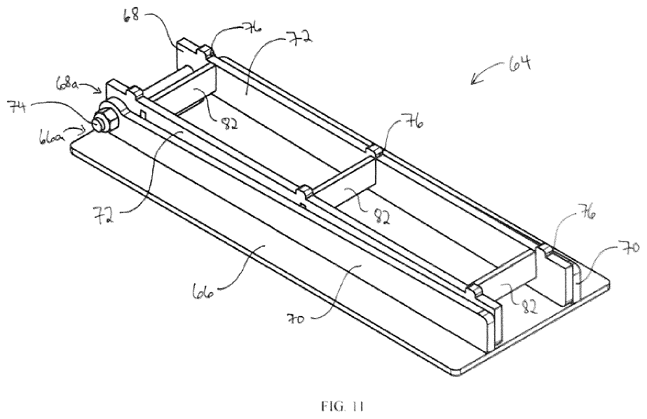

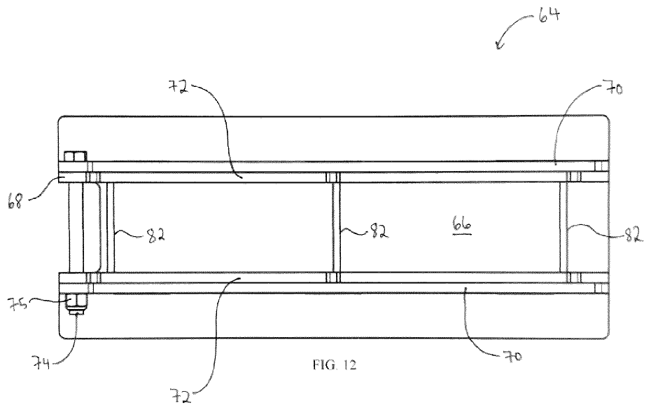

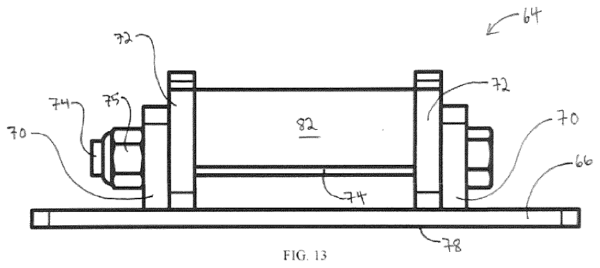

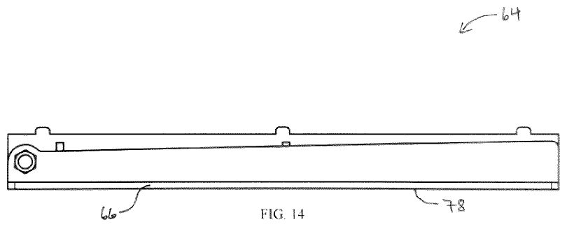

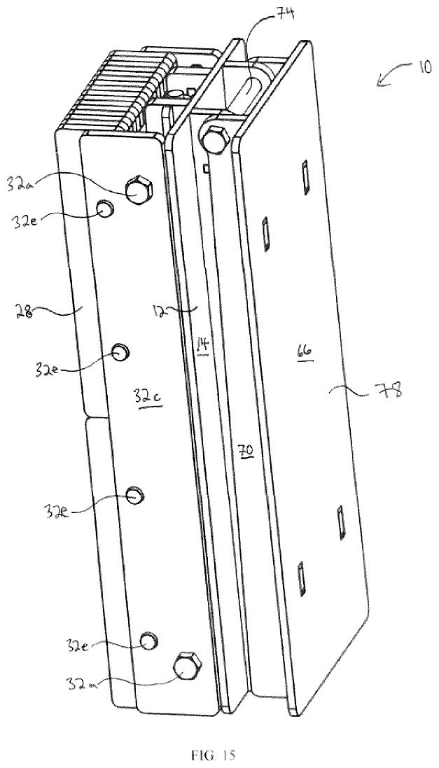

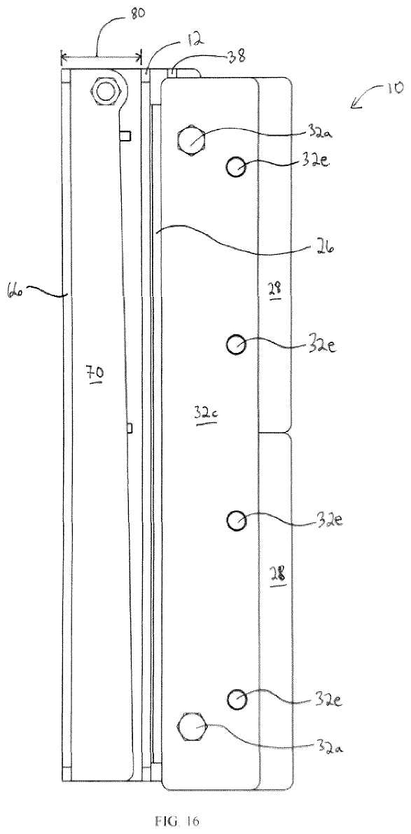

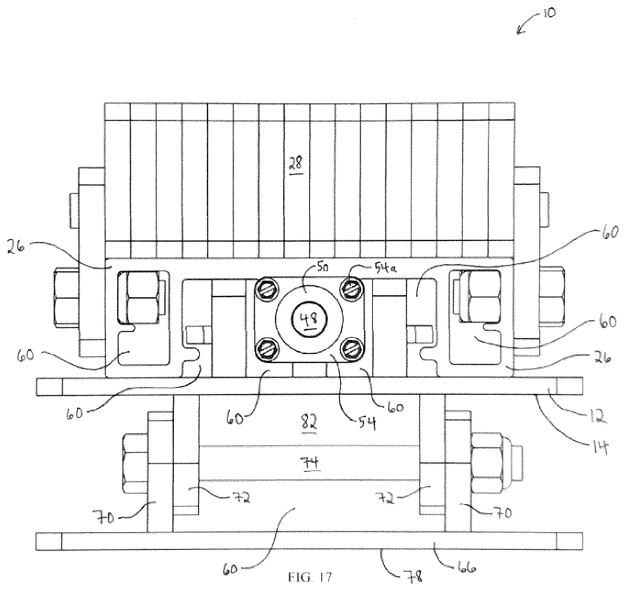

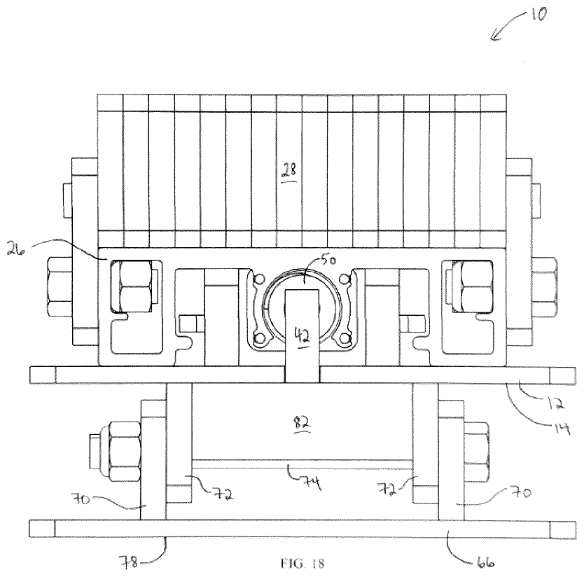

With reference to FIGS. 11-19, in accordance with some embodiments, the bumper apparatus 10 may be configured to accommodate sloped loading docks, so that the bumper 28 is able to make substantially flush contact with the rear end of a trailer that contacts the bumper apparatus 10 at, for example, a decline (such as when the trailer is docked at a declined loading dock) despite that the mounting structure 12 is attached to a generally vertical surface. For example, the bumper apparatus 10 may further comprise a tilt assembly 64 comprising a baseplate 66 and a tilt frame 68 pivotally attached to the baseplate 66 (such as by pivotal attachment of a top end 68a of the tilt frame 68 to a top end 66a of the baseplate 66). In order to achieve the pivotal attachment between the tilt frame 68 and the baseplate 66, the tilt frame 68 may comprise two spaced apart frame members 70 fixedly attached (such as by welded connection) to the baseplate 66 and projecting (such as orthogonally) from the baseplate 66. The tilt frame 68 may further comprise two tilting members 72 pivotally attached to, and between, the frame members 70, such as by a connecting rod 74 passing through the frame members 70 and the tilting members 72 generally at top ends thereof. The connecting rod 74 may comprise a bolt 74 attached at one end by a nut 75, as shown in the figures, or, for example, a rod that is passed through the frame members 70 and the tilting members 72 and welded at each end to the frame members 70. It will be appreciated that while the tilting members 72 are shown as being pivotally attached between the frame members 70, the tiling members 72 may instead be pivotally attached to the frame members 70 such that the frame members 70 lie between the tilting members 72. The tilt frame 68 of the tilt assembly 64 may comprise one or more cross members 82, which may impart further structural rigidity to the tilt assembly 64.

In tiltable embodiments, the tilt frame 68 may be fixable in angled relation to the baseplate 66. For example, as shown in FIG. 19, the tilt frame 68 may be angled relative to the baseplate 66 and welded in place (e.g., by welded connection between adjacent frame members 70 and tilting members 72), so as to fix the tilt frame 68 at a desired angle relative to the baseplate 66. In this way, when in use, the surface to which the mounting structure 12 is attachable may comprise a surface 76 of the tilt frame 68, and the bumper apparatus 10, including the tilt assembly 64, may be attached to another surface (e.g., the exterior wall of a loading dock warehouse, or for ease of reference, an “external surface”) via an attachment end 78 of the baseplate 66. In use, with the tilt frame 68 fixed in the desired angled relation relative to the baseplate 66 and the mounting structure 12 attached to the surface 76 of the tilt frame 68, the mounting structure 12 is also in the desired angled relation relative to the baseplate 66. As such, when the bumper apparatus 10 is attached to an external surface via the attachment end 78 of the baseplate 66, the removeable bumper assembly 16 is in the desired angled relation relative to the external surface.

The tilt frame 68 may be pivoted so as to form any required angle with the baseplate 66, such as an angle that is between and inclusive of 0° to 45°, for example, although larger angles are possible. In order to improve the strength of the welded connection between adjacent frame members 70 and tilting members 72, the bumper apparatus 10 may be tilted such that a welded connection can be maintained across substantially the full lengths of each of adjacent frame members 70 and tilting members 72, as shown in FIG. 19. In the 30 embodiment shown in FIG. 19, the angle formed between the tilt frame 68 and the baseplate 66 so as to maintain a welded connection across substantially the full lengths of each pair of adjacent frame members 70 and tilting members 72 is approximately 4.5°, although it will be appreciated that the maximum tilt angle that would permit such welded connection across substantially the full lengths of each pair of adjacent frame members 70 and tilting members 72 would depend on the dimensions of the frame members 70 and the tilting members 72 (e.g., in the embodiment shown in FIG. 19, with a maximum tilt angle of approximately 4.5° allowing for a welded connection across substantially the full lengths of each pair of adjacent frame members 70 and tilting members 72, the dimensions of each frame member 70 and tilting member 72 is approximately 20 inches long by approximately 1.5 inches wide along their lower edges 108 and approximately 1 inch wide along their upper edges 110). Where the angle required between the tilt frame 68 and the baseplate 66 is such that the welded connection between each pair of adjacent frame members 70 and tilting members 72 would not be sufficient to withstand the load of a trailer, the dimensions of the frame members 70 and tilting members 72 can be adjusted so as to maintain the required weld bead length between each pair of adjacent frame members 70 and tilting members 72, and/or an intermediate metal piece, such as steel plate (not shown) may be welded between each pair of adjacent frame members 70 and tilting members 72 to bridge the gap therebetween and improve the strength of the tilt assembly 64.

When attached to an external surface, the tilt assembly 64 may space the mounting structure 12 from the external surface by a distance 80 (see FIG. 16, showing distance 80 as measured when the tilt assembly 64 is not angled), which distance will depend on the dimensions of the tilt assembly 64. It will be appreciated that the horizontal distance 80 (when the bumper apparatus 10 is attached to a generally vertical external surface) will also depend, when the tilt assembly 64 is in an angled configuration, on the vertical point along the baseplate 66 at which the measurement is taken, as the mounting structure 12 will be at a further distance 80 from the external wall the further away from the pivotal attachment of the tilting members 72 to the frame members 70 that the measurement is taken.

It will be appreciated that the tilt assembly 64 may take on other configurations or arrangements than that shown in the figures, provided that it provides the ability to angle the mounting structure 12 (and thus the bumper assembly 16 and the bumper 28 thereof) relative to the external surface to which the bumper apparatus 10 is mounted. For example, the tilt assembly 64 may comprise a unitary welded piece with no connecting rod, in the configuration of an A-frame.

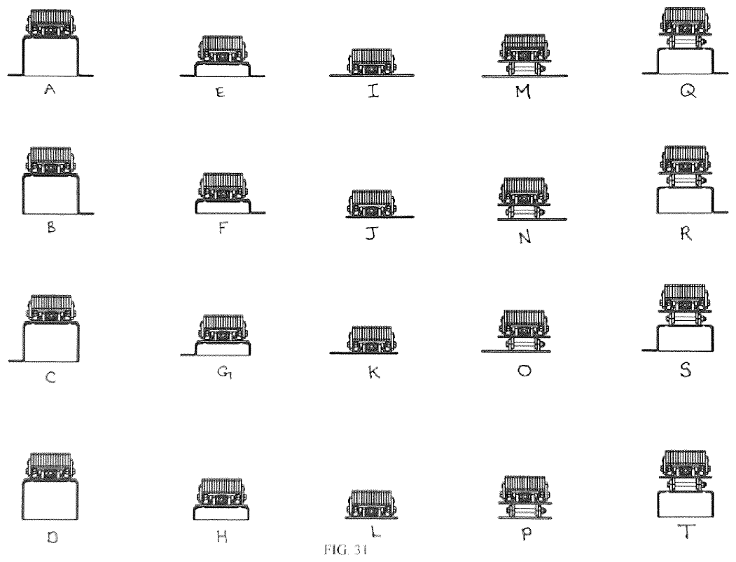

With reference to FIGS. 20-23, the bumper apparatus 10 may further comprise an extension apparatus 84, such that, in use, the surface to which the mounting structure 12 is attachable comprises a surface 86 of the extension apparatus 84, and the extension apparatus 84 is attached to an external surface via an attachment end 88 thereof, such that the extension apparatus 84 spaces the mounting structure 12 from the external surface by a distance 90 (see FIG. 22). In use, the extension apparatus 84 may be used to project the bumper(s) 28 a desired distance from the external surface to which the bumper apparatus 10 is mounted, for example to allow the bumper(s) 28 to sufficiently clear an overhead sill deck for a loading dock door. As shown in FIG. 31, distance 90 may comprise any required distance (see FIGS. 31A-D, each comprising an extension apparatus 84 providing for a first distance 90, FIGS. 31E-H, each comprising an extension apparatus 84 providing for a second distance 90, and FIGS. 31Q-T, each comprising a tilt assembly 64 comprising a baseplate spacing structure 102 (described further below, and providing a similar function to that of the extension apparatus 84) providing for a third distance 104 (see FIG. 25) intermediate to the first and second distances 90).

As shown in FIG. 21, the extension apparatus 84 may comprise one or more extension apparatus cross members 92 attached between side members 94. At least one of the cross members 92 may comprise a top cap 96, which may substantially shield an interior of the extension apparatus 84 from external environment elements, such as dirt, rain, snow or sleet, when the bumper apparatus 10 is attached to an external surface. In some embodiments, and as shown in FIG. 21, one of the cross members 92 may comprise the top cap 96 and another of the cross members 92 may comprise a bottom cap 98, such that the extension apparatus comprises a box-like structure with an open side, and may comprise one or more cross members 92 spanning a width of the extension apparatus within the box-like structure, attached between side members 94. It is expected that the cross members 92 and/or the side members 94 may impart structural rigidity to the extension apparatus 84, and through abutment with the external surface, may help to more evenly distribute a load or force applied against the bumper 28 toward the external surface to which the bumper apparatus 10 is mounted.

It will be appreciated that any of the embodiments discussed herein may be combined in any suitable manner. For example, the bumper apparatus 10 may comprise both a tilt assembly 64 and an extension apparatus 84, such as by attachment of the mounting structure 12 to the surface 76 of the tilt frame 68, and attachment of the tilt assembly baseplate 66 to a surface 86 of the extension apparatus 84.

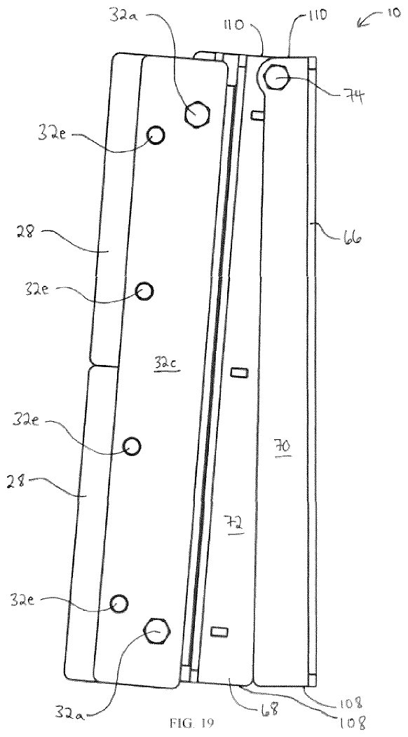

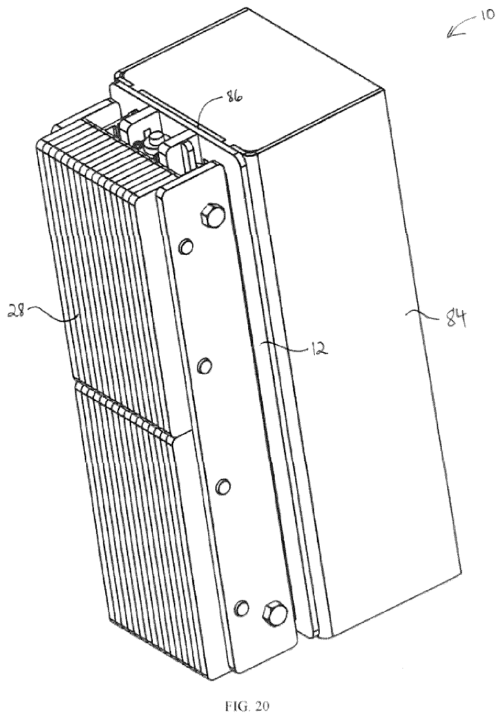

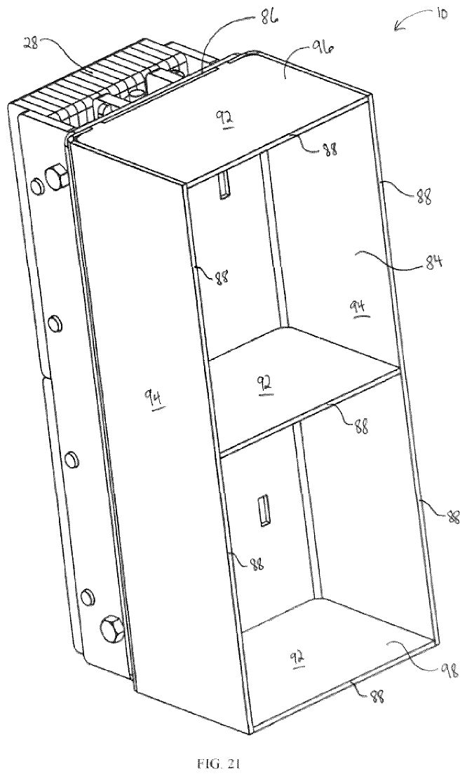

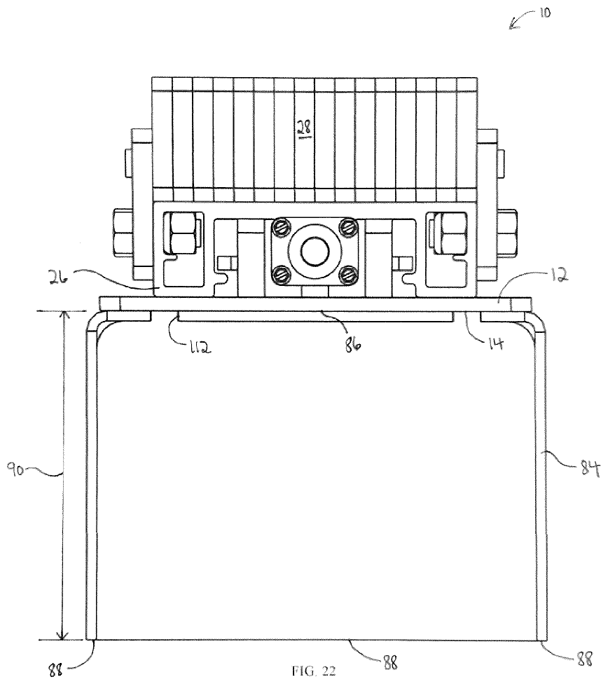

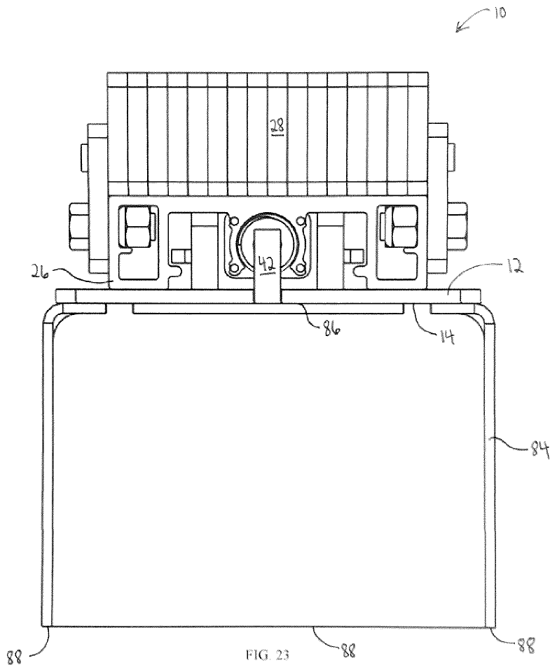

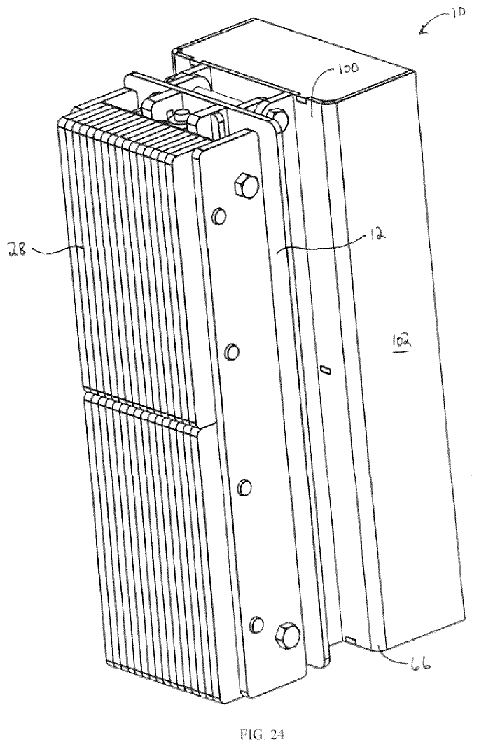

In yet other embodiments, the tilting and/or extension functions described herein may be achieved by mechanisms other than those described above. For example, with reference to FIGS. 24-26, in embodiments comprising the tilt assembly 64, rather than attaching the tilt assembly 64 to a separate extension apparatus 84, a more efficient construction may be achieved by using the tilt assembly baseplate 66 as the extension mechanism. For example, the baseplate 66 may comprise a tilt frame support surface 100 and a baseplate spacing structure 102 extending opposite the mounting structure 12 from the tilt frame support surface 100, such that in use, when the bumper apparatus 10 is attached to an external surface via the baseplate attachment end 78, the baseplate spacing structure 102 spaces the mounting structure 12 from the external surface by a further distance 104 (see FIG. 25) beyond the distance 80 (see FIG. 16). As shown in FIGS. 25 and 26, in such embodiments, the baseplate attachment end 78 may have a configuration other than that of the baseplate attachment end 78 shown in FIG. 15, such as a configuration similar to that of the attachment end 88 of an extension apparatus 84 (as shown in FIG. 21). Further, with reference to FIGS. 21 and 26, it will be appreciated that where the tilt assembly baseplate 66 comprises a baseplate spacing structure 102, the baseplate 66 shown in FIG. 26 may comprise a similar configuration to that of the extension apparatus 84 shown FIG. 21, including cross members 92, side members 94, a top cap 96, and/or a bottom cap 98, and thus function similarly to the extension apparatus 84, as described above.

Any of the embodiments and components thereof described herein may be attached to one another and/or to a surface or external surface by welding, bolting, screwing, keying, and the like, or any combination thereof (such as the connections 112 (see, e.g., FIGS. 4, 22 and 26), which may comprise keyed connections 112, friction fitting tabs 112, welded connections 112, or any suitable combination thereof). Further, any of the attachment mechanisms described herein, such as the mounting structure 12, the tilt assembly baseplate 66, the attachment end 78 of the baseplate 66, or the extension apparatus attachment end 88 (collectively, “attachment mechanisms”), may be rightwardly offset, leftwardly offset, or centrally disposed with respect to the slidably engaged removeable bumper assembly 16. FIGS. 27 to 31 show various configurations by which the bumper apparatus 10 may be attached to an external surface. For example, FIGS. 27A-D show a bumper apparatus 10, without a tilt assembly 64 or an extension apparatus 84, with a mounting structure 12 that is attachable to an external surface by bolting (FIG. 27A, showing a mounting structure 12 that is centrally disposed with respect to the bumper assembly 16, with side flanges 106), by a combination of bolting and welding (FIGS. 27B and C, showing a mounting structure 12 that is leftwardly offset (FIG. 27B, showing a left side flange 106) or rightwardly offset (FIG. 27C, showing a right side flange 106) with respect to the bumper assembly 16), or by welding (FIG. 27D, showing another embodiment of a mounting structure 12 that is centrally disposed with respect to the bumper assembly 16, with no side flanges 106).

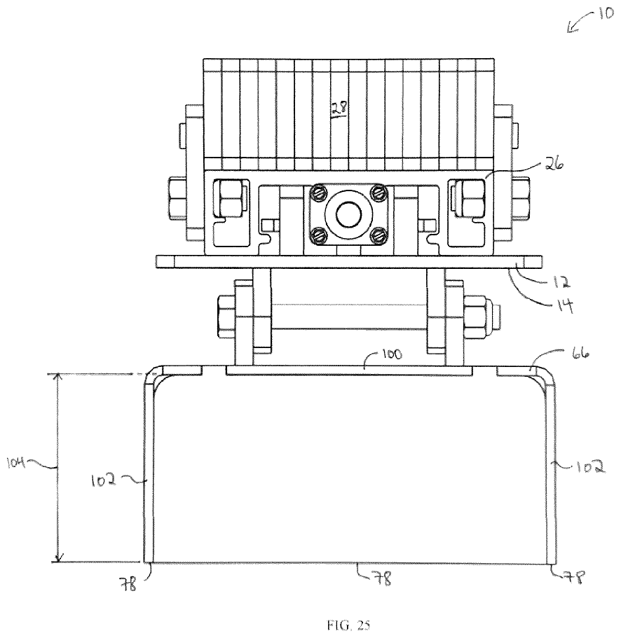

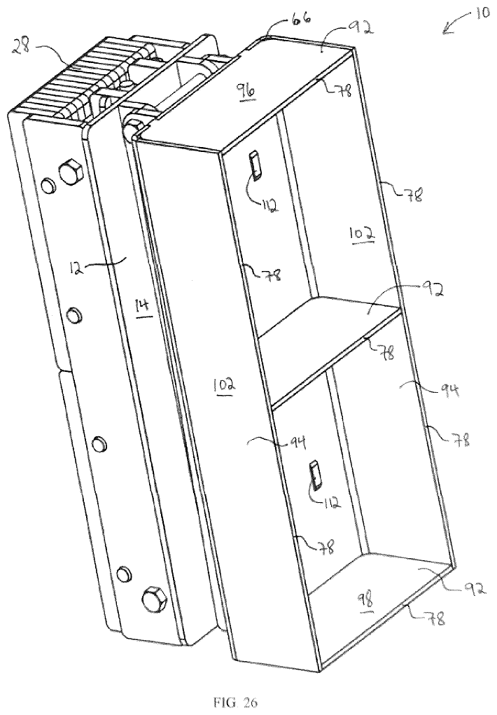

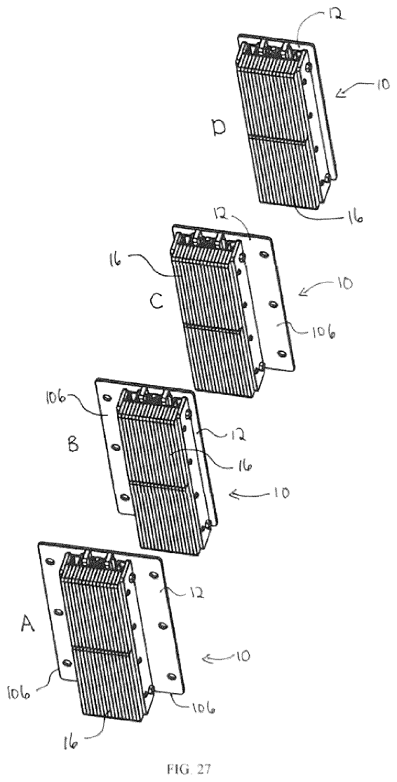

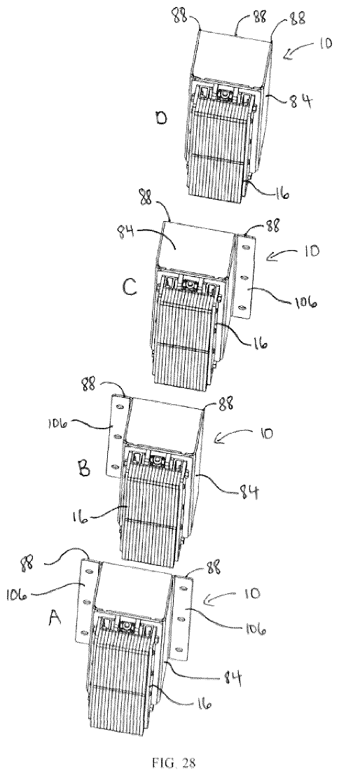

FIGS. 28A-D show a bumper apparatus 10 comprising an extension apparatus 84 but no tilt assembly 64, with an extension apparatus attachment end 88 that is attachable to an external surface by bolting (FIG. 28A, showing an extension apparatus attachment end 88 that is centrally disposed with respect to the bumper assembly 16, with side flanges 106), by a combination of bolting and welding (FIGS. 28B and C, showing an extension apparatus attachment end 88 that is leftwardly offset (FIG. 28B, showing a left side flange 106) or rightwardly offset (FIG. 28C, showing a right side flange 106) with respect to the bumper assembly 16), or welding (FIG. 28D, showing another embodiment of an extension apparatus attachment end 88 that is centrally disposed with respect to the bumper assembly 16, with no side flanges 106).

FIGS. 29A-D show a bumper apparatus 10 comprising a tilt assembly 64 but no extension apparatus 84 or baseplate spacing structure 102, with a tilt assembly baseplate 66 that is attachable to an external surface by bolting (FIG. 29A, showing a tilt assembly baseplate 66 that is centrally disposed with respect to the bumper assembly 16, with side flanges 106), by a combination of bolting and welding (FIGS. 29B and C, showing a tilt assembly baseplate 66 that is rightwardly offset (FIG. 29B, showing a right side flange 106) or leftwardly offset (FIG. 29C, showing a left side flange 106) with respect to the bumper assembly 16), or welding (FIG. 29D, showing another embodiment of a tilt assembly baseplate 66 that is centrally disposed with respect to the bumper assembly 16, with no side flanges 106).

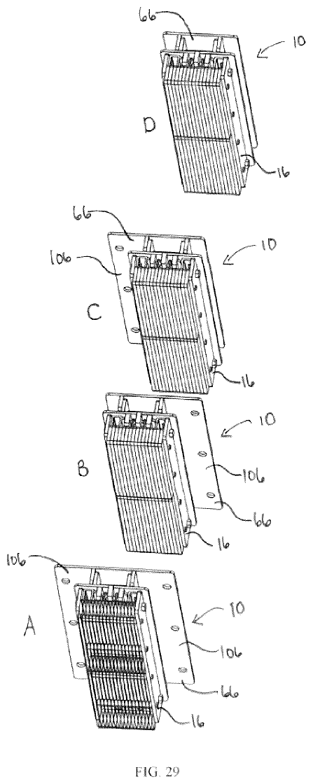

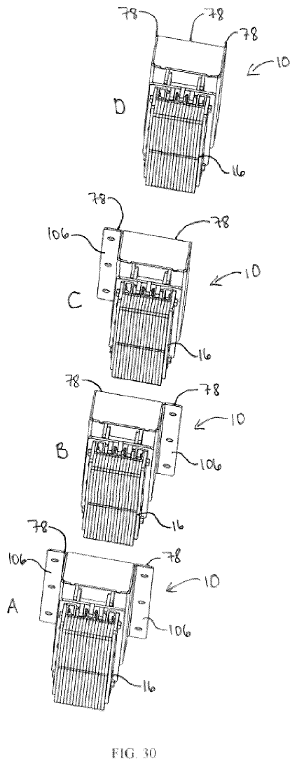

FIGS. 30A-D show a bumper apparatus 10 comprising a tilt assembly 64 comprising a baseplate spacing structure 102 and a baseplate attachment end 78, with a baseplate attachment end 78 that is attachable to an external surface by bolting (FIG. 30A, showing a baseplate attachment end 78 that is centrally disposed with respect to the bumper assembly 16, with side flanges 106), by a combination of bolting and welding (FIGS. 30B and C, showing a baseplate attachment end 78 that is rightwardly offset (FIG. 30B, showing a right side flange 106) or leftwardly offset (FIG. 30C, showing a left side flange 106) with respect to the bumper assembly 16), or welding (FIG. 30D, showing another embodiment of a baseplate attachment end 78 that is centrally disposed with respect to the bumper assembly 16, with no side flanges 106).

It will be appreciated that those portions of the attachment mechanisms depicted in FIGS. 27-30 that are shown without bolt holes may be attached to a surface (such as an external surface) by welded connection. Further, while those portions of the attachment mechanisms depicted in FIGS. 27-30 that are shown with bolt holes are capable of bolted connection, it will be appreciated that such portions may also, or alternatively, be attached to a surface (such as an external surface) by welded connection.

FIGS. 31A-T show different arrangements of the bumper apparatus 10. Generally, FIGS. 31A-D show embodiments of the bumper apparatus 10 comprising an extension apparatus 84 of one size, while FIGS. 31E-H show embodiments of the bumper apparatus 10 having an extension apparatus 84 of another size. FIGS. 311-L show embodiments of the bumper apparatus 10 having no tilt assembly 64 or extension apparatus 84. FIGS. 31M-P show embodiments of the bumper apparatus 10 having a tilt assembly 64. FIGS. 31Q-R show embodiments of the bumper apparatus 10 having a tilt assembly 64 comprising a baseplate spacing structure 102.

FIGS. 31A-T also show centrally disposed attachment mechanisms with side flanges (FIGS. 31A, E, I, M, and Q) or without side flanges (FIGS. 31D, H, L, P, and T). FIGS. 31B, F, J, N, and R show embodiments with attachment mechanisms having right side flanges, while FIGS. 31C, G, K, O, and S show embodiments with attachment mechanisms having left side flanges. Each of FIGS. 31A-D shows a bumper apparatus 10 comprising an extension apparatus 84 providing for a first distance 90 of the mounting structure 12 from an external surface to which the bumper apparatus 10 is mounted. Each of FIGS. 31E-H shows a bumper apparatus 10 comprising an extension apparatus 84 providing for a second distance 90 that is less than the first distance 90. Each of FIGS. 31Q-T shows a bumper apparatus 10 comprising a tilt assembly 64 comprising a baseplate spacing structure 102 providing for a third distance 104 intermediate to the first and second distances 90.

The bumper assembly 16 of the bumper apparatus 10 may be constructed so as to be a consumable, replaceable part. For example, with repeated use, the resilient bumper(s) 28 and/or the biasing mechanism 30 (such as a compression spring 30) may wear down and require replacement. Including the biasing mechanism 30 with the bumper 28 in a single removeable bumper assembly 16 is expected to facilitate replacement of the most likely parts to be worn with repeated use (i.e., the bumper 28 and the biasing mechanism 30), without having the replace the entire bumper apparatus 10 (i.e., both the bumper assembly 16 and the mounting structure 12, tilt assembly 64 (including those with a baseplate spacing structure 102) and/or extension apparatus 84). Furthermore, the mount engagement structure 26 may be formed from a first metal and the mounting structure 12 may be formed from a second metal, with the first metal being softer than the second metal such that, over time, the first metal of the mount engagement structure 26 of the bumper assembly 16 may wear down with repeated rubbing against the harder metal of the mounting structure 12. For example, the first metal, of the mount engagement structure 26, may comprise aluminum, and the second metal, of the mounting structure 12, may comprise steel. Further, the tilt assembly 64 and/or the extension apparatus 84 may similarly comprise a harder metal (e.g., steel) than that of the mount engagement structure 26.

By forming the mount engagement structure 26 from a softer metal than that of the mounting structure 12, the bumper apparatus 10 may be used without the need to lubricate (such as with grease) the points of contact 62 between the mount engagement structure 26 and the mounting structure 12, since the biasing mechanism 30, bumper 28, and mount engagement structure 26 of the bumper assembly 16 are all consumable components (the softer metal of the mount engagement structure 26 wearing down with repeated frictional engagement against the harder metal of the mounting structure 12), and as such, can be readily replaced by replacement of the bumper assembly 16.

As previously described, the cap 54, the biasing mechanism retention structure 44 (forming the recess or channel 46) and the mounting structure 12 may together substantially enclose the biasing mechanism 30 when the removable bumper assembly 16 is in the neutral position (as shown in FIG. 1) or the lowered position (as shown in FIGS. 1C and 1D). In this way, it is expected that the bumper apparatus 10 may substantially shield the biasing mechanism 30, such as the compression spring 30, from external environmental elements, such as dirt, snow, rain, or sleet, as well as from impact by external bodies, such as a trailer making contact with the bumper apparatus 10, which may increase the usable life of the spring 30, and which may in turn lead to less frequent replacement of the bumper assembly 16.

With reference to FIGS. 1F and 1G, once the bumper assembly 16 has been worn down to the point of requiring replacement, a user can readily remove the worn bumper assembly 16 by sliding the bumper assembly 16 upwards (relative to the generally vertically mounted mounting structure 12), away from the biasing mechanism retaining structure 42 of the mounting structure 12. Contact between the cap 54 and the upper terminating plate 50 (which is attached to the rod 48 passing longitudinally through the centre of the spring 30, which is in turn attached to the lower terminating plate 50) causes the upper terminating plate 50, and in turn the rod 48 and the lower terminating plate 50, and thus the biasing mechanism 30 (such as the compression spring 30), to move upward with the bumper assembly 16 until the bumper assembly 16 is isolated from the mounting structure 12, as shown in FIG. 1A. A new bumper assembly 16 can then be slid onto the mounting structure 12 through slidable engagement between the mount engagement structure 26 of the new bumper assembly 16 and the mounting structure 12, such as between the longitudinal tabs 40 of the longitudinal arms 36 of the mount engagement structure 26 and the longitudinal slide guides 38 of the bumper assembly engagement structure 20 of the mounting structure 12. As described above, the tolerances of the mount engagement structure 26 and the mounting structure 12 may be such that the removeable bumper assembly 16 can be slid relative to the mounting structure 12 with no or minimal friction between the mount engagement structure 26 and the mounting structure 12 (FIG. 10 showing no contact between the mount engagement structure 26 and the mounting structure 12). Such tolerances are expected to facilitate removal of the bumper assembly 16 from the mounting structure 12 or slidable engagement of a bumper assembly 16 with a mounting structure 12.

In accordance with example embodiments, the bumper apparatus 10 shown in FIG. 27A may have a width of approximately 13 inches, the bumper apparatus 10 shown in FIGS. 27B and C may each have a width of approximately 10.5 inches, and the bumper apparatus 10 shown in FIG. 27D may have a width of approximately 8 inches, with the height and depth of the bumper apparatus 10 shown in each of FIGS. 29A-D being the same, approximately 20 inches and 4.25 inches, respectively.

With reference to FIG. 29A, an example tilt assembly 64 with two side flanges 106 may have a width of approximately 13 inches. The bumper apparatus 10 shown in FIGS. 29B and C may each have a tilt assembly 64 with a width of approximately 10.5 inches, and the bumper apparatus 10 shown in FIG. 29D may have a tilt assembly 64 with a width of approximately 8 inches, with the height and depth of the bumper apparatus 10 shown in each of FIGS. 27A-D being the same, approximately 20 inches and 6.25 inches (the tilt assembly 64 adding approximately 2 inches of depth), respectively.

The width and height of each bumper apparatus 10 shown in each of FIGS. 28 and 30 may be substantially the same as for FIGS. 27 and 29, with the depth measurement changing by the depth of the extension apparatus 84 (FIG. 28) or the baseplate spacing structure 102 (FIG. 30). Each baseplate 66, mount plate 13, and/or extension apparatus 84 may comprise ¼ inch thick metal, such as ¼ inch thick steel.

The above dimensions are provided as example dimensions only, and it will be appreciated that the bumper apparatus 10, and the various components thereof, may be sized and dimensioned according to any requirements, provided that the functionalities described herein are maintained.

It is expected that the various configurations of the bumper apparatus 10 described herein may allow for a bumper apparatus 10 that may be suitable for various mounting scenarios. For example, the presently described subject-matter provides for a bumper apparatus 10 comprising an attachment mechanism, for mounting to an external surface, that is a mounting structure 12, or a tilt assembly baseplate 66 to provide a tilted 25 configuration, or an attachment end 78 of a tilt assembly baseplate 66 comprising a baseplate spacing structure 102, to provided a tilted configuration that is spaced from an external surface further than the spacing otherwise provided by a tilt assembly 64, or an extension apparatus attachment end 88 to provide for spacing from an external surface, and in each case the attachment mechanism capable of being rightwardly offset, leftwardly offset, or centrally disposed with respect to the slidably engaged removeable bumper assembly 16, with the baseplate spacing structures 102 or extension apparatuses 84 capable of being dimensioned as required to provide the desired spacing from an external surface. As can be seen from FIG. 31, which shows a subset of possible configurations, various configurations of the bumper apparatus 10 are possible, to accommodate various loading dock configurations. It will be appreciated that the baseplate spacing structures 102, extension apparatuses 84, and/or any other part or component(s) of the bumper apparatus 10 may be sized or dimensioned in any number of ways, and other than as shown in the figures or described herein, provided that the functionalities described herein are maintained.

It will be appreciated that other types of biasing mechanisms 30 than those described herein may be used, such as pneumatic mechanisms, as an example. It will be further appreciated that the biasing mechanism retaining structure 42 may be vertically positioned other than as shown in FIG. 1B, provided that it functions to stop downward movement of the lower end 58 of the compression spring assembly 52 so as to compress the compression spring 30 when the bumper assembly 16 is slid downward from the neutral position to a lowered position. It will also be appreciated that the removable and slidable engagement between the bumper assembly 16 and the mounting structure 12 may be achieved other than by the configuration described hereinabove, and further, that the functions of the bumper apparatus 10 described herein may be achieved by mechanisms and configurations other than those described herein, provided that the same advantages are achieved.

The above description is that of example embodiments. Various alterations and changes can be made without departing from the scope and broader aspects of the presently described subject-matter as set forth in the appended claims, which are to be interpreted in accordance with the principles of patent law. Further, the various features described herein of the various described embodiments may be combined in any suitable manner.

Unless otherwise explained, all technical terms used herein have the same meaning as commonly understood by one of ordinary skill in the art to which this disclosure belongs. It is also to be understood that the terminology used herein is for the purpose of describing particular aspects only and is not intended to be limiting.

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effect of the presently described subject-matter.

It will be understood that any component defined herein as being included may be explicitly excluded from the claimed subject-matter by way of proviso or negative limitation.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

1. A bumper apparatus comprising:
a mounting structure attachable to a surface on a mounting side of the mounting structure; and
a bumper assembly slidably and removably engaged with an engagement side of the mounting structure opposite the mounting side;
the mounting structure comprising a bumper assembly engagement structure extending longitudinally along the mounting structure, the bumper assembly engagement structure for said slidable engagement with the removeable bumper assembly, the bumper assembly slidable longitudinally along the bumper assembly engagement structure, and the bumper assembly engagement structure substantially retaining the bumper assembly laterally with respect to, and against, the mounting structure, the mounting structure comprising a biasing mechanism retaining structure attached generally to a bottom end of the mounting structure;
the removeable bumper assembly comprising:
a mount engagement structure,
a resilient bumper attached to the mount engagement structure, and
a biasing mechanism,
the mount engagement structure for said longitudinal slidable engagement with the bumper assembly engagement structure, the mount engagement structure comprising a biasing mechanism retention structure for retention of the biasing mechanism;
wherein, when the removable bumper assembly is longitudinally slidably engaged with the mounting structure, the removeable bumper assembly rests upon the biasing mechanism retaining structure in a neutral position when no unbalanced external force is applied at least partially longitudinally to the bumper assembly; and
wherein, when the removeable bumper assembly is acted upon by said unbalanced external force applied at least partially longitudinally to the bumper assembly toward said biasing mechanism retaining structure to move said removeable bumper assembly into a lowered position, the biasing mechanism biases the removeable bumper assembly upward, away from the biasing mechanism retaining structure toward the neutral position of the removeable bumper assembly.

2. The bumper apparatus of claim 1 wherein the biasing mechanism comprises one or more compression springs.

3. The bumper apparatus of claim 2 wherein the biasing mechanism comprises one of said one or more compression springs.

4. The bumper apparatus of claim 3 wherein the biasing mechanism retention structure comprises a channel formed longitudinally within the mount engagement structure, and a rod extending through a longitudinal axis of the compression spring, the rod comprising terminating plates attached to opposite ends thereof, the compression spring situated between the terminating plates, the compression spring, the rod and the terminating plates comprising a compression spring assembly, the terminating plates preventing movement of the compression spring off of the rod,
the biasing mechanism retention structure further comprising a cap attached atop the biasing mechanism and the channel, to the channel and about the rod such that the rod passes through the cap, such that downward movement of the bumper assembly causes downward movement of the cap to thereby compress the compression spring, the compression spring compressed through contact of an upper end of the compression spring against the cap and a lower end of the compression spring assembly against the biasing mechanism retaining structure.

5. The bumper apparatus of claim 4 wherein said lower end of the compression spring assembly abuts against the biasing mechanism retaining structure when the removable bumper assembly is in the neutral position or the lowered position.

6. The bumper apparatus of claim 4 wherein the cap, the channel and the mounting structure together substantially enclose the biasing mechanism when the removable bumper assembly is in the neutral position or the lowered position.

7. The bumper apparatus of claim 1 wherein, when:
the removable bumper assembly is longitudinally slidably engaged with the mounting structure and the mounting structure is attached to the generally vertical surface, and
a load is applied against the resilient bumper toward the generally vertical surface,
a force of the applied load is distributed from the mount engagement structure to the mounting structure through at least four points of contact therebetween.

8. The bumper apparatus of claim 7 wherein the at least four points of contact are generally evenly distributed across a width of the mount engagement structure.

9. The bumper apparatus of claim 1 wherein, when:
the removable bumper assembly is longitudinally slidably engaged with the mounting structure and the mounting structure is attached to the generally vertical surface, and no load is applied against the resilient bumper toward the generally vertical surface, tolerances of the mount engagement structure and the mounting structure are such that the removeable bumper assembly can be slid relative to the mounting structure with no or minimal friction between the mount engagement structure and the mounting structure.

10. The bumper apparatus of claim 1 wherein the mount engagement structure is formed from a first metal and the mounting structure if formed from a second metal, the first metal being softer than the second metal.

11. (canceled)

12. The bumper apparatus of claim 1 wherein the mounting structure is rightwardly offset, leftwardly offset, or centrally disposed with respect to the slidably engaged removeable bumper assembly.

13. The bumper apparatus of claim 1 further comprising a tilt assembly comprising:
a baseplate; and
a tilt frame pivotally attached to the baseplate, the tilt frame being fixable in angled relation to the baseplate;
wherein, in use:
the tilt frame is fixed in said angled relation to the baseplate;
the surface to which the mounting structure is attachable comprises a surface of the tilt frame, such that the mounting structure, attached to the surface, is in said angled relation relative to the baseplate; and
the bumper apparatus is attached to another surface via an attachment end of the baseplate, such that the removeable bumper assembly is in said angled relation relative to the another surface,
the tilt assembly spacing the mounting structure from the another surface by a distance.

14. The bumper apparatus of claim 13 wherein the baseplate is rightwardly offset, leftwardly offset, or centrally disposed with respect to the slidably engaged removeable bumper assembly.

15. The bumper apparatus of claim 1 further comprising an extension apparatus, wherein, in use, the surface to which the mounting structure is attachable comprises a surface of said extension apparatus, and the extension apparatus is attached to another surface via an attachment end thereof, the extension apparatus spacing the mounting structure from the another surface.

16. The bumper apparatus of claim 15 wherein the extension apparatus attachment end is rightwardly offset, leftwardly offset, or centrally disposed with respect to the slidably engaged removeable bumper assembly.

17. The bumper apparatus of claim 13 wherein the baseplate comprises a tilt frame support surface and a baseplate spacing structure extending opposite the mounting structure from the tilt frame support surface,
wherein, in use, when the bumper apparatus is attached to said another surface via the baseplate attachment end, the baseplate spacing structure spaces the mounting structure from the another surface by a further distance, beyond the distance.

18. The bumper apparatus of claim 17 wherein the baseplate attachment end is rightwardly offset, leftwardly offset, or centrally disposed with respect to the slidably engaged removeable bumper assembly.

19-20. (canceled)

21. A bumper apparatus comprising:
a mounting structure attachable to a surface, and
a bumper assembly slidably and removably engaged with the mounting structure;
the mounting structure comprising a bumper assembly engagement structure;
the bumper assembly comprising:
a mount engagement structure for longitudinal slidable engagement with the bumper assembly engagement structure,
a resilient bumper attached to the mount engagement structure, and
a biasing mechanism;
wherein, in use:
the removeable bumper assembly rests upon a biasing mechanism retaining structure attached generally to a bottom end of the mounting structure, in a neutral position when no unbalanced external force is applied at least partially longitudinally to the bumper assembly; and
when the removeable bumper assembly is acted upon by said unbalanced external force applied at least partially longitudinally to the bumper assembly toward the biasing mechanism retaining structure to move the bumper assembly into a lowered position, the biasing mechanism biases the bumper assembly upward, toward the neutral position.

22. A bumper apparatus for engaging a transport vehicle at a loading dock, the bumper apparatus comprising:
a mounting structure for mounting to the loading dock;
a bumper assembly comprising a resilient bumper for engaging the transport vehicle;
a mount engagement structure for engaging the mounting structure; and
a biasing mechanism for biasing the bumper assembly in a longitudinal position relative to the mounting structure when the mount engagement structure is engaged with the mounting structure,
wherein the mount engagement structure comprises a pair of guide channels in which are received flanges of the mounting structure, when the mount engagement structure is engaged with the mounting structure, to guide movement of the mount engagement structure in a longitudinal direction relative to the mounting structure,
wherein, when the mount engagement structure is engaged with the mounting structure, the bumper assembly is longitudinally moveable relative to the mounting structure from an unbiased neutral position, when no unbalanced external force is applied at least partially longitudinally to the bumper assembly, to a biased position in response to an unbalanced external force applied at least partially longitudinally to the bumper assembly, and
wherein, when the bumper assembly is acted upon by an unbalanced external force applied at least partially longitudinally to the bumper assembly to longitudinally move the bumper assembly relative to the mounting structure, the biasing mechanism biases the bumper assembly toward the neutral position.
